(19) United States
(12) Patent Application Publication
(10) Pub. No.: US 2026/0117949 A1
(43) Pub. Date: Apr. 30, 2026

(54) VEHICLE LIGHT SOURCE DEVICE AND VEHICLE LIGHTING FIXTURE

(71) Applicant: NICHIA CORPORATION, Anan-shi (JP)

(72) Inventor: Midori HAYASHI, Komatsushima-shi (JP)

(73) Assignee: NICHIA CORPORATION, Anan-shi (JP)

(21) Appl. No.: 19/364,713

(22) Filed: Oct. 21, 2025

(30) Foreign Application Priority Data
Mar. 13, 2025 (JP) 2025-040713
Oct. 25, 2024 (JP) 2024-188165

(51) Int. Cl. F21S 41/176; F21S 41/153

(52) U.S. Cl. CPC F21S 41/176; F21S 41/153

(57) ABSTRACT

A vehicle light source device includes: a plurality of light sources arranged in two rows and n columns, wherein n is a natural number of 4 or greater, the plurality of light sources including: a plurality of first light sources arranged in a row direction in a first row, each of the first light sources comprising a first light emitting element and a first light transmissive member arranged on the first light emitting element, and a plurality of second light sources arranged in the row direction in a second row, each of the second light sources comprising a second light emitting element and a second light transmissive member arranged on the second light emitting element.

### CROSS-REFERENCE TO RELATED APPLICATION

The present application claims priority under 35 U.S.C. §119 to Japanese Patent Application No. 2024-188165, filed October 25, 2024, and Japanese Patent Application No. 2025-040713, filed March 13, 2025, the contents of which are incorporated herein by reference in their entireties.

### BACKGROUND

The present disclosure relates to a vehicle light source device and vehicle lighting fixture.

Conventionally, light emitting devices including light emitting elements, such as Light Emitting Diodes (LEDs) and the like, have been known. For example, Japanese Patent Application Laid-Open Publication No. 2019-197824 discloses a light emitting device and a vehicle lighting fixture having a plurality of light emitting units each having a light emitting element and a light transmissive substrate covering the upper surface of the light emitting element. According to the light emitting device and the vehicle lighting fixture, the light transmissive substrates of the light emitting units, among the plurality of light emitting units, that are located on the outer periphery, have extension parts extending in a direction from the upper surfaces of the light emitting elements toward the outer periphery.

### SUMMARY

Light source devices for vehicles are required to irradiate light onto a traffic sign or the like provided vertically above the roads on which the vehicles travel. An object of certain embodiments of the present disclosure is to provide a vehicle light source device and a vehicle lighting fixture capable of irradiating a vertically upward region with a wide light distribution pattern.

A vehicle light source device according to an embodiment of the present disclosure includes a plurality of light sources arranged in two rows and n columns, wherein n is a natural number of 4 or greater, the plurality of light sources including: a plurality of first light sources arranged in a row direction in a first row, each of the first light sources including a first light emitting element and a first light transmissive member arranged on the first light emitting element, and a plurality of second light sources arranged in the row direction in a second row, each of the second light sources including a second light emitting element and a second light transmissive member arranged on the second light emitting element. The vehicle light source device is configured to irradiate, by individually driving the plurality of the first light sources and the plurality of the second light sources, a light distribution pattern onto an irradiation region of the vehicle light source device such that the irradiation region includes a cut-off line in at least a part of the irradiation region, the at least the part of the irradiation region being between (i) a group of positions corresponding to the plurality of the first light sources and (ii) a group of positions corresponding to the plurality of the second light sources. Each of the second light sources has a length in a column direction that is greater than that of the first light sources.

A vehicle lighting fixture according to an embodiment of the present disclosure includes: the vehicle light source device described above; and a lens configured to transmit light emitted from the vehicle light source device.

According to an embodiment of the present disclosure, a vehicle light source device and a vehicle lighting fixture capable of irradiating a vertical upward region with a wide light distribution pattern can be provided.

### BRIEF DESCRIPTION OF THE DRAWINGS

FIG. 1 is a schematic plan view showing an overall configuration of a vehicle light source device according to a first embodiment;

FIG. 2 is a schematic plan view showing a plurality of light sources included in the vehicle light source device according to the first embodiment;

FIG. 3A is a first example of a schematic cross-sectional view along a line III-III in FIG. 2;

FIG. 3B is a second example of the schematic cross-sectional view along the line III-III in FIG. 2;

FIG. 4 is a schematic cross-sectional view showing a detailed configuration of a first light emitting element included in the vehicle light source device according to the first embodiment;

FIG. 5 is a schematic plan view showing a plurality of light sources included in the vehicle light source device according to a first modification of the first embodiment;

FIG. 6 is a schematic cross-sectional view along a line VI-VI in FIG. 5;

FIG. 7 is a schematic plan view showing a plurality of light sources included in the vehicle light source device according to a second modification of the first embodiment;

FIG. 8 is a schematic plan view showing a plurality of light sources included in a vehicle light source device according to a second embodiment;

FIG. 9A is a first example of a schematic cross-sectional view along a line IX-IX in FIG. 8;

FIG. 9B is a second example of the schematic cross-sectional view along the line IX-IX in FIG. 8;

FIG. 10 is a schematic plan view showing a plurality of light sources included in a vehicle light source device according to a third embodiment;

FIG. 11 is a schematic plan view showing a plurality of light sources included in a vehicle light source device according to a fourth embodiment;

FIG. 12 is a schematic plan view showing a plurality of light sources included in a vehicle light source device according to a fifth embodiment;

FIG. 13 is a schematic plan view showing a plurality of light sources included in a vehicle light source device according to a sixth embodiment;

FIG. 14 is a schematic cross-sectional view showing a configuration of a vehicle lighting fixture according to a seventh embodiment;

FIG. 15 is a schematic view showing a vehicle light source device of the vehicle lighting fixture according to the seventh embodiment;

FIG. 16A is a schematic view showing a high-beam light distribution pattern of the vehicle lighting fixture according to the seventh embodiment;

FIG. 16B is a schematic view showing a low-beam light distribution pattern of the vehicle lighting fixture according to the seventh embodiment;

FIG. 17 is a schematic plan view showing an overall configuration of a vehicle light source device according to an eighth embodiment;

FIG. 18 is a schematic plan view showing a plurality of light sources included in the vehicle light source device according to the eighth embodiment;

FIG. 19A is a first example of a schematic cross-sectional view along an XIX-XIX line of FIG. 18;

FIG. 19B is a second example of the schematic cross-sectional view along the XIX-XIX line of FIG. 18;

FIG. 19C is a third example of the schematic cross-sectional view along the XIX-XIX line of FIG. 18;

FIG. 19D is a fourth example of the schematic cross-sectional view along the XIX-XIX line of FIG. 18; and

FIG. 20 is a schematic view showing an overall configuration of a vehicle according to a ninth embodiment.

### DETAILED DESCRIPTION

The vehicle light source device and a vehicle lighting fixture according to embodiments of the present disclosure will be described in detail with reference to the drawings. However, the following embodiments are for illustrating the vehicle light source device and the vehicle lighting fixture that implement the technical idea of the present disclosure, and the following embodiments are non-limiting. The dimensions, materials, shapes, relative positionings, and the like of the components described in the embodiments are not intended to limit the scope of the present disclosure only to these particulars, and are merely illustrative examples, unless it is stated that the scope of the present disclosure is limited to specific embodiments. The size, positional relationship, and the like of the components shown in the respective drawings may be exaggerated for clarity of explanation. Also, in the following description, the same names and reference numerals refer to the same or similar components, and detailed explanation thereof will be omitted where appropriate. As a cross-sectional view, an end view showing only the sectioned surface may be used.

In each drawing, orthogonal coordinates including X, Y, and Z axes are used as a directional representation. The X, Y, and Z axes are orthogonal to each other. The direction in which the arrow faces in the X direction is denoted as the +X side, and the side opposite to the +X side is denoted as the -X side. The direction in which the arrow faces in the Y direction is denoted as the +Y side, and the side opposite to the +Y side is denoted as the -Y side. The direction in which the arrow faces in the Z direction is denoted as the +Z side, and the side opposite to the +Z side is denoted as the -Z side.

The X direction along the X axis corresponds to a row direction in which a plurality of first light sources and a plurality of second light sources included in a vehicle light source device according to the embodiments are arranged side by side, respectively. The Z direction along the Z axis corresponds to the direction normal to light emitting surfaces of light sources included in the vehicle light source device according to the embodiments. The Z direction corresponds to the direction normal to a first upper surface region of each first light source included in the vehicle light source device according to the embodiments. The Y direction along the Y axis corresponds to a column direction crossing the row direction and the normal direction. In this specification, the X direction is denoted as a row direction X. The Y direction is denoted as a column direction Y. The Z direction is denoted as a normal direction Z. The Y direction corresponds to the vertical direction when the vehicle light source device according to the embodiments is used. The +Y side corresponds to a “vertically upper side” in the irradiation region irradiated with a light distribution pattern by the vehicle light source device according to the embodiments when the vehicle light source device is used. The -Y side corresponds to a “vertically lower side” in the irradiation region. The terms “vertically upper side,” “vertically upward,” and “vertically above” means the upper side in the vertical direction, in other words, in the gravity direction. The terms “vertically lower side” and “vertically below” means the lower side in the vertical direction.

In this specification, phrases like “viewed in a plan view” means that an object is viewed from the side faced by the light emitting surfaces of the light sources included in the vehicle light source device according to the embodiments, which is, for example, the +Z side. A surface, on the +Z side, of a first light transmissive member of a light source included in the vehicle light source device corresponds to “an upper surface of the first light transmissive member.” There may be a case where not only any part that is directly visible from the side faced by the light emitting surfaces, but any part that is not directly visible from the side faced by the light emitting surfaces are also described using the phrases like “viewed in a plan view” as if it were seen through. The term “plan view” means a view of an object as viewed from the side faced by the light emitting surfaces.

The phrase “along the X, Y and Z axes” encompasses that an object has an inclination within a range of ±20° with respect to these axes. “Orthogonal” encompasses an inclination within ±20° with respect to 90°. “Equal or the same” encompasses an error within ±10%. “Arranging, disposing, situating, placing, and the like” are not limited to arranging, disposing, situating, placing, and the like into a direct contacting state, but also include arranging, disposing, situating, placing, and the like into an indirect contacting state, for example, via another member.

In this specification or the claims, when there are multiple components and they are expressed separately, the components may be distinguished by affixing “first,” “second,” and the like at the head of the components. There may be a case where the objects to be distinguished in the specification and the objects to be distinguished in the claims are different. Therefore, even if the claims recite components that are denoted by the same affixes as used in the specification, the objects identified by these components in the claims may not match objects denoted by these affixes in the specification.

### First Embodiment

### Configuration of Vehicle Light Source Device according to First Embodiment

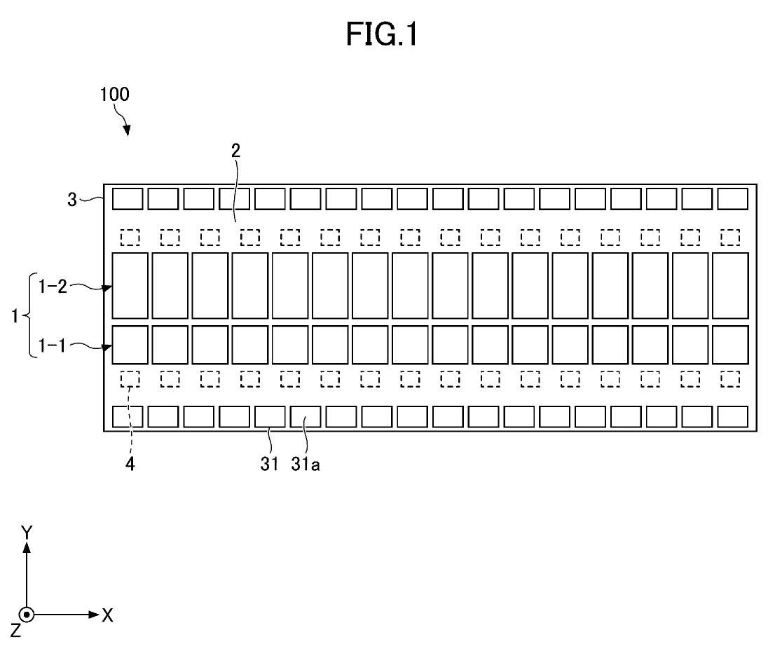

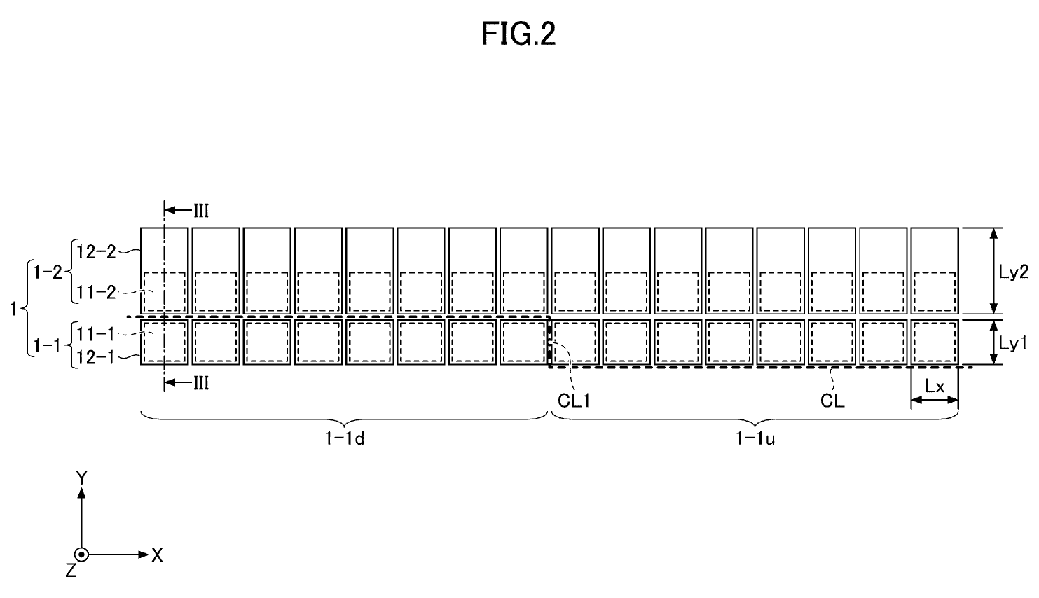

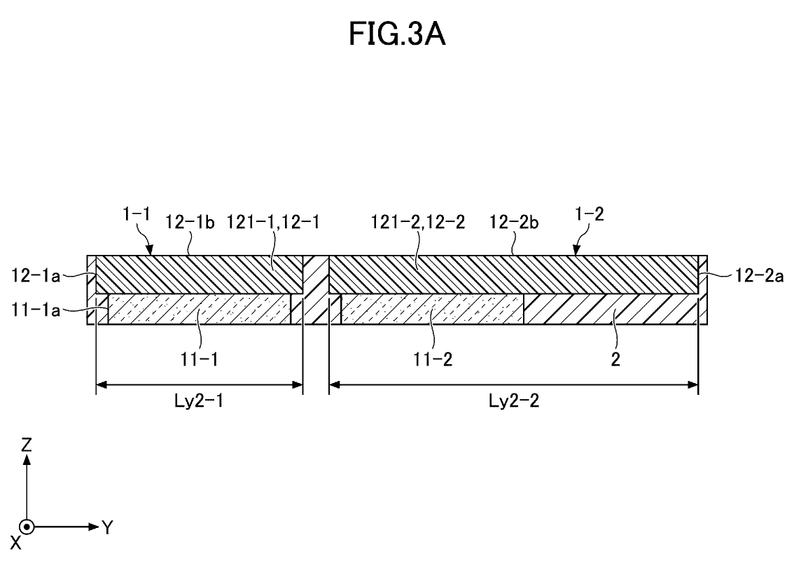

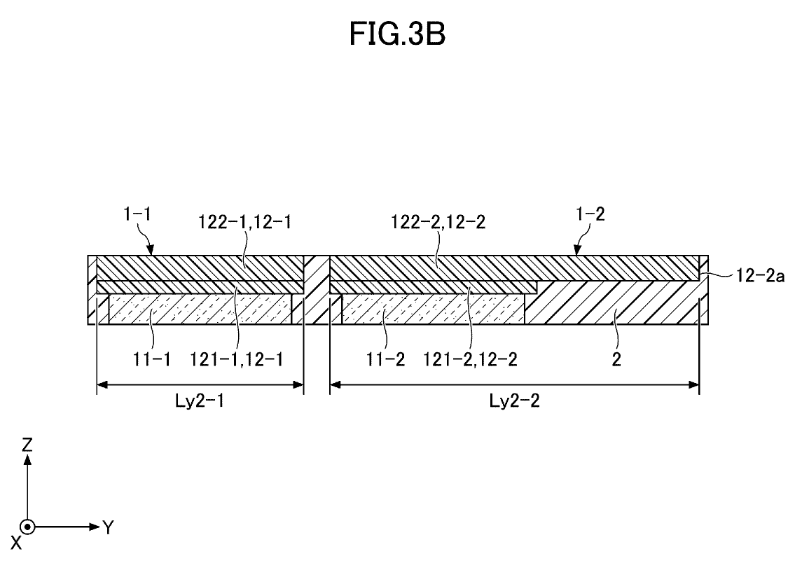

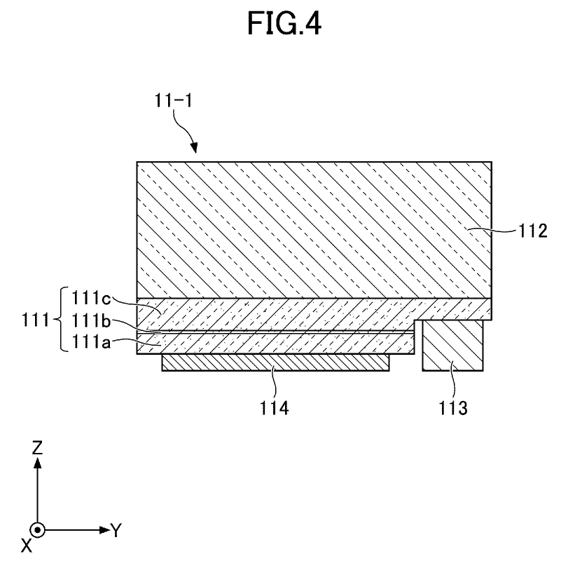

With reference to FIGS. 1, 2, 3A, 3B, and 4, the configuration of the vehicle light source device according to a first embodiment will be described. FIG. 1 is a schematic plan view showing the overall configuration of the vehicle light source device 100 according to the first embodiment. FIG. 2 is a schematic plan view showing a first example of a plurality of light sources 1 included in the vehicle light source device 100. FIG. 3A is a first example of a schematic cross-sectional view along a line III-III in FIG. 2. FIG. 3B is a second example of the schematic cross-sectional view along the line III-III in FIG. 2. FIG. 4 is a schematic cross-sectional view showing a detailed configuration of a first light emitting element 11-1 included in the vehicle light source device 100.

The vehicle light source device 100 is a vehicle light source device used in a vehicle lighting fixture, such as automobile headlights and the like, and is capable of emitting mainly light that is distributed in a high-beam light distribution. As shown in FIG. 1, the vehicle light source device 100 includes a plurality of light sources 1 arranged in two rows and n columns, where n is a natural number of 4 or greater. In the example shown in FIG. 1, the vehicle light source device 100 includes a light shielding member 2 holding the plurality of light sources 1 collectively, a wiring board 3 including wirings 31 electrically connected to the plurality of light sources 1, and protective elements 4 arranged on the wiring board 3 and covered with the light shielding member 2.

As shown in FIGS. 2, 3A, and 3B, the plurality of light sources 1 include a plurality of first light sources 1-1 arranged in the row direction X in a first row and a plurality of second light sources 1-2 arranged in the row direction X in a second row.

In FIG. 2, the length Ly1 represents the length of the first light sources 1-1 in the column direction Y. The length Ly2 represents the length of the second light sources 1-2 in the column direction Y. The length Lx represents the length of each of the first light sources 1-1 and each of the second light sources 1-2 in the row direction X. In the present embodiment, the length Ly2 is greater than the length Ly1. In other words, the length of the second light sources 1-2 in the column direction Y is greater than that of the length of the first light sources 1-1. In the example shown in FIG. 2, the first light sources 1-1 and the second light sources 1-2 have the same length in the row direction X. The length Ly1 is equal to the length Lx. The length Ly2 is greater than the length Lx.

As shown in FIGS. 3A and 3B, each first light source 1-1 includes a first light emitting element 11-1 and a first light transmissive member 12-1 disposed on the first light emitting element 11-1. Each second light source 1-2 includes a second light emitting element 11-2 and a second light transmissive member 12-2 disposed on the second light emitting element 11-2. The upper surface of the first light transmissive member 12-1 in each first light source 1-1 and the upper surface of the second light transmissive member 12-2 in each second light source 1-2 are the main light extraction surfaces of the first light source 1-1 and the second light source 1-2, respectively. In the upper surface of the vehicle light source device, the upper surfaces of the first light transmissive members 12-1 and the upper surfaces of the second light transmissive members 12-2 are exposed from the light shielding member 2, and constitute a plurality of light emitting surfaces provided in the vehicle light source device. In the upper surface of the vehicle light source device, it is preferable that the upper surfaces of the first light transmissive members 12-1 and the upper surfaces of the second light transmissive members 12-2 are coplanar with each other.

In the first example shown in FIG. 3A, the first light transmissive member 12-1 includes a first phosphor. The second light transmissive member 12-2 includes a second phosphor. The first phosphor is a wavelength conversion material that converts at least a part of light incident from the first light emitting element 11-1 into light having a different wavelength. The second phosphor is a wavelength conversion material that converts at least a part of light incident from the second light emitting element 11-2 into light having a different wavelength.

In the second example shown in FIG. 3B, the first light transmissive member 12-1 includes a first phosphor part 121-1 including a first phosphor, and a first light transmissive part 122-1 disposed on the first phosphor part 121-1 and not containing the first phosphor. The second light transmissive member 12-2 includes a second phosphor part 121-2 including a second phosphor, and a second light transmissive part 122-2 disposed on the second phosphor part 121-2 and not containing the second phosphor. In FIG. 3B, to indicate that the first light transmissive member 12-1 includes the first phosphor part 121-1, the first light transmissive member 12-1 and the first phosphor part 121-1 are shown together. To indicate that the second light transmissive member 12-2 includes the second phosphor part 121-2, the second light transmissive member 12-2 and the second phosphor part 121-2 are shown together. In the following figures, for the same purpose, reference numerals may be shown together.

In FIG. 3A, the length Ly2-1 represents the length of the first light transmissive member 12-1 in the column direction Y. The length Ly2-2 represents the length of the second light transmissive member 12-2 in the column direction Y. In the present embodiment, the length Ly2-2 is greater than the length Ly2-1. In other words, the length of the second light transmissive member 12-2 in the column direction Y is greater than that of the first light transmissive member 12-1.

The first light source 1-1 outputs light emitted from the first light emitting element 11-1 to the +Z side through the first light transmissive member 12-1. The second light source 1-2 outputs light emitted from the second light emitting element 11-2 to the +Z side through the second light transmissive member 12-2. The vehicle light source device 100 outputs light emitted from the plurality of light sources 1 to the +Z side.

The light output from the vehicle light source device 100 is irradiated onto an irradiation region. The irradiation region is, for example, a region that is along a plane orthogonal to an axis extending along the traveling direction of a vehicle mounted with the vehicle light source device 100.

The vehicle light source device 100 allows for obtaining a selected desired light distribution pattern in which a portion to be irradiated is selected in the irradiation region of the vehicle light source device 100 by individually controlling the turning on and off of each of the plurality of light sources 1. By individually controlling the turning on and off of each of the plurality of first light sources 1-1 and the plurality of second light sources 1-2, a vehicle lighting fixture including the vehicle light source device 100 can perform, for example, Adaptive Driving Beam (ADB) irradiation. In the following description, controlling the turning on and off of each of the plurality of light sources 1 and the plurality of second light sources 1-2 is referred to as lighting control.

By the lighting control, the vehicle light source device 100 according to the present embodiment can irradiate a light distribution pattern onto an irradiation region of the vehicle light source device 100 such that the light distribution pattern includes a cut-off line CL in at least a part of the irradiation region, the at least the part of the irradiation region being between (i) a group of positions that correspond to irradiation from the plurality of first light sources 1-1 and (ii) a group of positions that correspond to irradiation from the plurality of second light sources 1-2. The cut-off line CL indicated by a bold dashed line in FIG. 2 represents the boundary between a low beam irradiation region and a high beam irradiation region in the irradiation region of the vehicle light source device 100. By the lighting control, the vehicle light source device 100 can perform irradiation with: at least a part of the low-beam light distribution pattern; and the high-beam light distribution pattern. In the low-beam distribution pattern, in the irradiation region of the vehicle light source device 100, the vertically lower side of the positions corresponding to the cut-off line CL is irradiated with light, and the vertically upper side of the positions corresponding to the cut-off line CL is not irradiated with light.

In some cases, on the road where the vehicle travels, a traffic sign or the like indicating the destination of the road is installed on the vertically upper side of the region ahead of the vehicle in the traveling direction. In order for the traffic sign or the like to be clearly visible to the driver of the vehicle in a dark environment, such as nighttime, it is necessary for a vehicle lighting fixture mounted on the vehicle to emit light to the vertically upper side of the region ahead of the vehicle in the traveling direction. In order for the traffic sign or the like installed at a high place on the vertically upper side of the region ahead of the vehicle in the traveling direction to be clearly visible, it is preferable to irradiate the high position on the vertically upper side with light from the vehicle lighting fixture. Note that the “height on the vertically upper side” means the length to the vertically upper side from the road surface of the road on which the vehicle travels. For example, the “height on the vertically upper side” being high means that the length to the vertically upper side from the road surface of the road is long.

In the present embodiment, the second light source 1-2, which is disposed on the +Y side of the first light source 1-1 and is turned on when emitting light in the high-beam light distribution pattern, has a length in the column direction Y that is greater than that of the first light source 1-1. With the length of the second light source 1-2 greater than the length of the first light source 1-1 in the column direction Y, the light distribution pattern emitted from the second light source 1-2 of the vehicle light source device 100 can be extended to the +Y side compared with the first light source 1-1. Thus, in the present embodiment, it is possible to provide the vehicle light source device 100 that can emit a light distribution pattern widened at the vertically upper side, which corresponds to the +Y side. For example, in the present embodiment, it is possible to provide the vehicle light source device 100 that can emit a light distribution pattern widened at the vertically upper side of the cut-off line CL as the high-beam light distribution pattern. In the present embodiment, it is possible to provide the vehicle light source device 100 that can emit a high-beam light distribution pattern wider at the vertically upper side of the cut-off line CL and can perform adaptive driving beam irradiation.

In the example shown in FIG. 2, in the row direction X, the lengths of the first light source 1-1 and the second light source 1-2 are both the length Lx and equal to each other. The length Ly1 of the first light source 1-1 in the column direction Y is equal to the length Lx of the second light source 1-2. The length Ly2 is greater than the length Lx.

With the length Ly1 and the length Lx being equal, the spreading angle of the light distribution pattern on the vertically lower side and the spreading angle of the light distribution pattern in the horizontal direction are equal to each other in the region ahead of the vehicle, mounted with the vehicle light source device 100, in the traveling direction. Because the length Ly2 is greater than the length Lx, the spreading angle of the light distribution pattern on the vertically upper side is larger than the spreading angle of the light distribution pattern on the vertically lower side and the spreading angle of the light distribution pattern in the horizontal direction. Thus, in the region ahead of the vehicle, mounted with the vehicle light source device 100, in the traveling direction, the vehicle light source device 100 can make the spreading angle of the light distribution pattern on the vertically upper side larger than the spreading angle of the light distribution pattern in the directions other than the direction to the vertically upper side.

In the example shown in FIG. 2, it is possible to realize the light distribution suitable as the above-mentioned high beam, by preventing the light distribution pattern from being wide in any directions other than the direction to the vertically upper side. In addition, it is possible to irradiate light onto a traffic sign installed on the vertically upper side of the region ahead of the vehicle in the traveling direction in a dark environment, such as nighttime and the like, by spreading the light distribution pattern to the vertically upper side. As a result, while realizing a light distribution suitable as the high beam, the vehicle light source device 100 allows a traffic sign installed on the vertically upper side of the region ahead of the vehicle in the traveling direction to be clearly visible to the driver of the vehicle in a dark environment, such as nighttime and the like. In addition, by the lighting control, the vehicle light source device 100 can realize a light distribution pattern suitable for the adaptive driving beam irradiation. Thus, it is possible to reduce light pollution, such as dazzling the driver of an oncoming vehicle and any person present around the road in at least one direction, and the like.

The plurality of light sources 1 provided in the vehicle light source device 100 are not limited to the number corresponding to, and the arrangement of, 2 rows and 16 columns shown in FIGS. 1 and 2. For example, the plurality of light sources 1 can be arranged in the number corresponding to, and the arrangement of, 2 rows or greater and 4 rows or less and 4 columns or greater and 25 columns or less. When the plurality of light sources 1 are arranged in 3 rows or 4 rows, the second light sources 1-2 are arranged in the row direction X in the row that is the furthest on +Y side so as to be used for the high-beam light distribution pattern. With such a number and an arrangement, it is possible to realize the light distribution suitable as the high beam and to allow a driver of a vehicle to clearly recognize a traffic sign installed on the vertically upper side of the region ahead of the vehicle in the traveling direction in a dark environment, such as nighttime and the like.

It is preferable that the second light transmissive member 12-2 is longer in the column direction Y than the first light transmissive member 12-1. Thus, the length Ly2 of the second light source 1-2 can be made greater than the length Ly1 of the first light source 1-1 in the column direction Y.

It is preferable that the vehicle light source device 100 includes the light shielding member 2 holding the plurality of light sources 1 collectively. By the upper surfaces of the plurality of light sources 1 (that is, the main light emitting surfaces of the light sources 1) being exposed from the light shielding member 2 and the light to be output via the side surfaces of the plurality of light sources 1 to the sides being shielded by the light shielding member 2, flare light is reduced. By reducing the flare light, the vehicle light source device 100 can emit a light distribution pattern having a large luminance difference, i.e., a high contrast between the light irradiation region and a non-irradiation region. Moreover, with the light-reflective light shielding member 2, the light extraction efficiency of the vehicle light source device 100 is increased.

In the first example shown in FIG. 3A, the first light transmissive member 12-1 includes the first phosphor part 121-1, and the second light transmissive member 12-2 includes the second phosphor part 121-2. Mixing the light emitted from the first light emitting element 11-1 and the second light emitting element 11-2 with the light emitted from the first phosphor part 121-1 and the second phosphor part 121-2 increases the degree of freedom in selecting the color of the light emitted from the vehicle light source device 100. However, the configuration of the first light transmissive member 12-1 and the second light transmissive member 12-2 is not limited to the first example shown in FIG. 3A. For example, as in the second example shown in FIG. 3B, the first light transmissive member 12-1 may include the first phosphor part 121-1 and the first light transmissive part 122-1, and the second light transmissive member 12-2 may include the second phosphor part 121-2 and the second light transmissive part 122-2. With the configuration of the second example as well, an effect substantially the same as in the first example can be obtained. Moreover, the configuration of the first light transmissive member 12-1 and the second light transmissive member 12-2 may be the combination of the first example and the second example. For example, there may be a case in which the first light transmissive member 12-1 includes the first phosphor part 121-1 and does not include the first light transmissive part 122-1, and the second light transmissive member 12-2 includes the second phosphor part 121-2 and the second light transmissive part 122-2. Also, there may be a case in which the first light transmissive member 12-1 includes the first phosphor part 121-1 and the first light transmissive part 122-1, and the second light transmissive member 12-2 includes the second phosphor part 121-2 and does not include of the second light transmissive part 122-2.

In the example shown in FIG. 2, the irradiation region of the vehicle light source device 100, the plurality of first light sources 1-1 include a plurality of lower first light sources 1-1d capable of irradiating a region below the cut-off line CL (that is, capable of emitting a low-beam light distribution pattern), and a plurality of upper first light sources 1-1u capable of irradiating a region above the cut-off line CL (that is, capable of emitting a high-beam light distribution pattern). The region below the cut-off line CL is, for example, the -Y side. The region above the cut-off line CL is, for example, the +Y side. From another aspect, the cut-off line CL shown in FIG. 2 includes a column direction line CL1 extending in the column direction Y at the center in the row direction X. On the -X side of the column direction line CL1, the cut-off line CL is located in a column-direction-Y between the first light sources 1-1 and the second light sources 1-2. On the other hand, on the +X side of the column direction line CL1, the cut-off line CL is located on the -Y side of the first light sources 1-1.

When emitting light in the low-beam light distribution pattern, in the vehicle light source device 100, the lower first light sources 1-1d located on the -X side of the column direction line CL1 are turned on. When emitting the high-beam light distribution pattern, in the vehicle light source device 100, the upper first light sources 1-1u and the second light sources 1-2 located on the +X side of the column direction line CL1 are turned on. Thus, in the irradiation region of the vehicle light source device 100, a high-beam light distribution pattern capable of irradiating the positions corresponding to the upper first light sources 1-1u and the positions corresponding to all of the second light sources 1-2 is obtained. For example, the driver of an oncoming vehicle traveling in the lane on the opposite side of the lane on which the vehicle mounted with the vehicle light source device 100 travels is prevented from being dazzled by the high-beam light distribution pattern from the vehicle.

By a combination with an optical system, such as a lens and the like, the vehicle light source device 100 can form the cut-off line CL at positions to which a desired light distribution pattern can be emitted. The position of the column direction line CL1 is not limited to the center in the row direction X, and may be a position that is offset by a predetermined distance from the center in the row direction X to the +X side or to the -X side.

Hereinafter, each component of the vehicle light source device 100 will be described in detail.

### First Light Emitting Element 11-1 and Second Light Emitting Element 11-2

The first light emitting element 11-1 and the second light emitting element 11-2 may have the same configuration. Therefore, in the following description, the first light emitting element 11-1 will be described as a representative component.

In the example shown in FIG. 4, the first light emitting element 11-1 includes one or more laminates in each of which a first semiconductor layer 111a, a light emitting layer 111b, and a second semiconductor layer 111c are laminated in the thickness direction, e.g., in the normal direction Z. In the example shown in FIG. 4, the first light emitting element 11-1 includes a first laminate 111, a light transmissive substrate 112 disposed on the first laminate 111, a cathode electrode 113 disposed on the side opposite to the light transmissive substrate 112, and an anode electrode 114.

The first laminate 111 includes the first semiconductor layer 111a, the light emitting layer 111b disposed on the first semiconductor layer 111a, and the second semiconductor layer 111c disposed on the light emitting layer 111b. The first semiconductor layer 111a is, for example, a p-GaN layer. The second semiconductor layer 111c is, for example, an n-GaN layer. The anode electrode 114 is disposed on the first semiconductor layer 111a. The cathode electrode 113 is disposed on the second semiconductor layer 111c. The light transmissive substrate 112 is, for example, a sapphire substrate.

The materials of the first semiconductor layer 111a, the light emitting layer 111b, and the second semiconductor layer 111c can be suitably selected according to the wavelength of the light to be emitted. For emission of blue or green light, ZnSe, nitride semiconductor, or GaP can be selected as the materials of the first semiconductor layer 111a, the light emitting layer 111b, and the second semiconductor layer 111c. As the nitride semiconductor, a semiconductor having a composition obtained by changing the composition ratios x and y in the chemical formula InₓAl_{y}Ga_{1-x-y}N (where 0≤x≤1, 0≤y≤1, x+y≤1) can be used. For emission of red light, a nitride semiconductor represented by GaAlAs or AlInGaP can be selected as the materials of the first semiconductor layer 111a, the light emitting layer 111b, and the second semiconductor layer 111c. Furthermore, a semiconductor material made of materials other than these may be used. The composition, light emission color, size, number, and the like of the first semiconductor layer 111a, the light emitting layer 111b, and the second semiconductor layer 111c can be selected appropriately according to the purpose. In the first example shown in FIG. 3A, a side surface 11-1a of the first light emitting element 11-1 is covered with the light shielding member 2. The thickness of the first light emitting element 11-1 may be approximately 30 μm or greater and 150 μm or less. However, this is non-limiting, and the thickness of the first light emitting element 11-1 can be changed appropriately.

### First Light Transmissive Member 12-1 and Second Light Transmissive Member 12-2

In the first example shown in FIG. 3A, the first light transmissive member 12-1 is joined to the upper surface of the first light emitting element 11-1. The first light transmissive member 12-1 can be joined to the first light emitting element 11-1 via, for example, a light transmissive joining member. The first light transmissive member 12-1 is made of a material that can transmit light emitted from the first light emitting element 11-1 for the light to be extracted to the outside.

A side surface 12-1a of the first light transmissive member 12-1 is covered with the light shielding member 2. Since the light shielding member 2 has a light-shielding property, an upper surface 12-1b of the first light transmissive member 12-1 serves as the main light emitting surface (that is, the light extraction surface) of the first light source 1-1. Examples of the first light transmissive member 12-1 include one that can transmit 60% or more, preferably 70% or more of the light from the first light emitting element 11-1 or light resulting from the light from the first light emitting element 11-1 being wavelength-converted, for example, light having an emission peak wavelength in a wavelength range of 320 nm or greater and 850 nm or less.

The second light transmissive member 12-2 is joined to the upper surface of the second light emitting element 11-2. The second light transmissive member 12-2 can be joined to the second light emitting element 11-2 via, for example, a light transmissive joining member. The second light transmissive member 12-2 is made of a material that can transmit the light emitted from the second light emitting element 11-2 for the light to be extracted to the outside.

A side surface 12-2a of the second light transmissive member 12-2 is covered with the light shielding member 2. Since the light shielding member 2 is has a light-shielding property, an upper surface 12-2b of the second light transmissive member 12-2 serves as the light emitting surface of the second light source 1-2. Examples of the second light transmissive member 12-2 include on that can transmit 60% or more, preferably 70% or more of the light from the second light emitting element 11-2 or light resulting from the light from the second light emitting element 11-2 being wavelength-converted, for example, light having an emission peak wavelength in a wavelength range of 320 nm or greater and 850 nm or less.

The length of the first light transmissive member 12-1 in the column direction Y is different from that of the second light transmissive member 12-2. The first light transmissive member 12-1 is different from the second light transmissive member 12-2 in that it contains a first phosphor whereas the second light transmissive member 12-2 contains the second phosphor. Except for these points, the first light transmissive member 12-1 and the second light transmissive member 12-2 are the same. Therefore, the following description, the first light transmissive member 12-1 will be described as a representative component. The following description can also be applied to the second light transmissive member 12-2 by replacing the first phosphor with the second phosphor. The first light transmissive member 12-1 and the second light transmissive member 12-2 may emit light having the same color or different colors.

Materials constituting the first light transmissive member 12-1 include, for example, inorganic materials such as glass, ceramic, sapphire, silicone resin, modified silicone resin, epoxy resin, modified epoxy resin, resin containing one or more of acrylic resin, phenolic resin, fluororesin, or organic materials such as hybrid resin.

Specifically, the first light transmissive member 12-1 containing the first fluorophore may be a material in which powder of the first fluorophore is contained in the above-mentioned materials constituting the first light transmissive member 12-1, such as sintered bodies of the first fluorophore or glass containing the first fluorophore. In addition, a translucent layer such as a resin layer containing the first fluorophore or a glass layer containing the first fluorophore may be disposed on the surface of a molded body such as resin, glass or ceramic. In addition, the first light transmissive member 12-1 may contain a filler such as a light diffuser according to the purpose. When a filler such as a light diffuser is contained, the filler may be contained in resin, glass, ceramic or other inorganic substances, or a translucent layer such as a resin layer containing the filler or a glass layer containing the filler may be disposed on the surface of a translucent plate which is a molded body such as resin, glass or ceramic.

As the first phosphor, it is possible to use yttrium aluminum garnet-based phosphor (for example, (Y,Gd)₃(Al,Ga)₅O₁₂:Ce), lutetium aluminum garnet-based phosphor (for example, Lu₃(Al,Ga)₅O₁₂:Ce), terbium aluminum garnet-based phosphor (for example, Tb₃(Al,Ga)₅O₁₂:Ce), CCA-based phosphor (for example, Ca₁₀(PO₄)₆Cl₂:Eu), SAE-based phosphor (for example, Sr₄Al₁₄O₂₅:Eu), chlorosilicate-based phosphor (for example, Ca₈MgSi₄O₁₆Cl₂:Eu), silicate-based phosphor (for example, (Ba,Sr,Ca,Mg)₂SiO₄:Eu), oxynitride-based phosphor, such as a β sialon-based phosphor (for example, (Si,Al)₃(O,N)₄:Eu), an α sialon-based phosphor (for example, Ca(Si,Al)₁₂(O,N)₁₆:Eu), nitride-based phosphor, such as LSN-based phosphor (for example, (La,Y)₃Si₆N₁₁:Ce), BSESN-based phosphor (for example, (Ba,Sr)₂Si₅N₈:Eu), SLA-based phosphor (for example, SrLiAl₃N₄: Eu), a CASN phosphor (for example, CaAlSiN₃:Eu), SCASN-based phosphor (for example, (Sr,Ca)AlSiN₃:Eu), and the like, fluoride-based phosphor, such as a KSF-based phosphor (for example, K₂SiF₆:Mn), KSAF-based phosphor (for example, K₂(Si₁₋ₓAlₓ)F₆₋ₓ:Mn where x satisfies 0<x<1), MGF-based phosphor (for example, 3.5MgO·0.5MgF₂·GeO₂:Mn), and the like, quantum dots having a perovskite structure (for example, (Cs,FA,MA)(Pb,Sn)(F,Cl,Br,I)₃ where FA and MA represent formamidinium and methylammonium, respectively), Group II-VI quantum dots (for example, CdSe), Group III-V quantum dots (for example, InP), quantum dots having a chalcopyrite structure (for example, (Ag,Cu)(In,Ga)(S,Se)₂), and the like.

By combining these first phosphors and a blue light emitting element or an ultraviolet light emitting element that can excite these first phosphors, it is possible to produce a vehicle light source device 100 that emits light having various colors, for example, a vehicle light source device 100 that emits white light. In order for the vehicle light source device 100 to emit white light, the type and the concentration of the first phosphor contained in the first light transmissive member 12-1 are adjusted in order to obtain white light. The concentration of the first phosphor contained in the first light transmissive member 12-1 is, for example, 5% by mass or greater and 50% by mass or less.

By including the first phosphor in the first light transmissive member 12-1, it is possible to convert the color of the light emitted from the first light emitting element 11-1 into a different color via the first phosphor. Thus, the variety of colors of the light emitted from the vehicle light source device 100 can be improved. It is preferable that the first light transmissive member 12-1 has a high light transmissivity to visible light. The thickness of the first light transmissive member 12-1 may be 30 μm or greater and 100 μm or less. However, this is non-limiting, and the thickness of the first light transmissive member 12-1 may be appropriately changed.

For example, titanium oxide, barium titanate, aluminum oxide, silicon oxide, yttrium aluminum, perovskite, and the like can be used as a light diffusing material that can be contained in the first light transmissive member 12-1.

The first phosphor and the second phosphor contained in the first light transmissive member and the second light transmissive member 12-2 may be the same type of phosphor or different types of phosphor. The same type of phosphor means to encompass a case in which the emission color is the same, a case in which the composition is the same, or a case in which the crystal structure is the same (for example, a case in which both have the same garnet structure, which is a yttrium/aluminum/garnet-based phosphor).

### First Phosphor Part 121-1 and Second Phosphor Part 121-2

The same configuration as that of the first light transmissive member 12-1 can be applied to the first phosphor part 121-1 except, for example, the size, thickness, and the like. The same configuration as that of the second light transmissive member 12-2 can be applied to the second phosphor part 121-2 except, for example, the size, thickness, and the like.

### First Light Transmissive Part 122-1 and Second Light Transmissive Part 122-2

The same configuration as that of the first light transmissive member 12-1 can be applied to the first light transmissive part 122-1 except, for example, the size, thickness, absence of the first phosphor, and the like. The same configuration as that of the second light transmissive member 12-2 can be applied to the second light transmissive part 122-2 except, for example, the size, thickness, absence of the second phosphor, and the like.

### Light Shielding Member 2

The light shielding member 2 covers and seals the side surfaces of the first light emitting element 11-1, the second light emitting element 11-2, the first light transmissive member 12-1, and the second light transmissive member 12-2. The light shielding member 2 can protect the first light emitting element 11-1 and the second light emitting element 11-2 from external force, dust, gas, and the like by sealing the first light emitting element 11-1 and the second light emitting element 11-2. The light shielding member 2 can improve heat resistance, weather resistance, and light resistance of the first light emitting element 11-1, the second light emitting element 11-2, and the like by sealing the first light emitting element 11-1 and the second light emitting element 11-2.

The light shielding member 2 has a light shielding property. When the light shielding member 2 has light reflectivity as the light shielding property, the light shielding member 2 can reflect light that is output via the side surfaces of the first light emitting element 11-1, the second light emitting element 11-2, the first light transmissive member 12-1, and the second light transmissive member 12-2 so as for the light to be output via the upper surface 12-1b of the first light transmissive member 12-1 and the upper surface 12-2b of the second light transmissive member 12-2. Thus, the light extraction efficiency of the vehicle light source device 100 can be enhanced.

When the light shielding member 2 has light absorbability as a light shielding property, the light shielding member 2 can absorb light that is output via the side surfaces of the first light emitting element 11-1, the second light emitting element 11-2, the first light transmissive member 12-1, and the second light transmissive member 12-2, thereby reducing light extraction from regions other than the upper surface of the first light transmissive member 12-1 and the upper surface of the second light transmissive member 12-2. Thus, the luminance difference between the light emitting part, i.e. the light emitting surface of the vehicle light source device 100, and the non-light emitting part, i.e. the upper surface of the light shielding member 2, becomes clear, and the vehicle light source device 100 can have a high contrast between the light emitting surfaces.

As the material of the light shielding member 2, an insulating resin, for example, a thermosetting resin, such as epoxy resin, silicone resin, and the like can be suitably used as a matrix material. In addition, as the light shielding member 2, an inorganic material containing boron nitride and alkali metal silicate may be used as a matrix material. Moreover, it is possible to impart light reflectivity to the light shielding member 2, by adding particles of a light reflecting material in any of these matrix materials to form the light shielding member 2 as a white member. Examples of the light reflecting material include titanium oxide, silicon oxide, zirconium oxide, aluminum oxide, magnesium oxide, calcium carbonate, calcium hydroxide, calcium silicate, zinc oxide, barium titanate, potassium titanate, aluminum nitride, boron nitride, mullite, combinations thereof, and the like. Among them, titanium oxide is preferable because it is relatively stable in moisture and has a high refractive index. It is possible to impart light absorbability to the light shielding member 2 by dispersing particles of a light absorbing material, such as carbon black, titanium black, graphite, and the like in the matrix material to form the light shielding member 2 as a black member. The light shielding member 2 may be a gray member obtained by dispersing particles of a light reflecting material and a light absorbing material in the matrix material.

It is preferable that the light shielding member 2 has a light shielding property that shields equal to or greater than 60%, more preferably equal to or greater than 80% the light emitted from, for example, the first light emitting element 11-1 and the second light emitting element 11-2. In a plan view of the vehicle light source device 100, the distance between adjacent light sources 1, that is, the thickness of the light shielding member 2 disposed between the light sources 1, can be 5 μm or greater and 50 μm or less. The shorter the distance between adjacent light sources 1, the smaller the size of the vehicle light source device 100 can be. The longer the distance between adjacent light sources 1, the more light propagation in the lateral direction is reduced.

### Wiring Board 3

The wiring board 3 is a member on which the first light emitting elements 11-1, the second light emitting elements 11-2, and the protective elements 4 are mounted. The wiring board 3 includes the wirings 31 for supplying electric power from the outside and a base material for supporting the wirings. The wirings 31 are disposed at least on the upper surface of the wiring board 3 so as to constitute a predetermined electric circuit. In the present embodiment, the wirings 31 are partially exposed from the light shielding member 2 on the upper surface of the wiring board 3, and the exposed regions serve as terminals 31a for connecting to the outside.

The wirings 31 include the terminals 31a by a number that is greater at least by one than the total number of the first light emitting elements 11-1 and the second light emitting elements 11-2 provided in the vehicle light source device 100. In the example shown in FIG. 1, the vehicle light source device 100 includes thirty-six terminals 31a. The thirty-six terminals 31a are arranged along the row direction X in the same manner as the first light emitting elements 11-1 and the second light emitting elements 11-2 on the upper surface of the wiring board 3.

For example, the wirings 31 can connect the first light emitting elements 11-1 and the second light emitting elements 11-2 in series. The wirings 31 connecting the first light emitting elements 11-1 and the second light emitting elements 11-2 in series are partially exposed at the upper surface of the vehicle light source device 100 as the terminals 31a for external connection. By controlling the voltages applied to these terminals 31a, it is possible to individually drive the sixteen first light emitting elements 11-1 and the sixteen second light emitting elements 11-2 mounted on the wiring board 3. For example, the vehicle light source device 100 may include a plurality of circuits in which two or more of the first light emitting elements 11-1 and two or more of second light emitting elements 11-2 are serially connected, respectively.

In the example herein, every four terminals 31a of the thirty-six terminals 31a of the vehicle light source device 100 constitute an independent series circuit. Specifically, the vehicle light source device 100 includes eight circuits each including four terminals 31a for serially connecting four light emitting elements. Thus, for example, it is possible to separate the circuits for controlling the first light sources 1-1 from the circuits for controlling the second light source 1-2, and to perform the lighting control more easily.

In the vehicle light source device 100, since the wiring board 3 includes the wirings 31 capable of supplying electric power to the first light emitting elements 11-1 and the second light emitting elements 11-2 individually, it is possible to cause the first light emitting elements 11-1 and the second light emitting elements 11-2 to emit light individually through the wirings 31. This makes it easy to control the vehicle light source device 100.

As the base material of the wiring board 3, it is preferable to use an insulating material, and it is preferable to use a material that rarely transmits light emitted from the first light emitting elements 11-1 and the second light emitting elements 11-2, external light, and the like. It is preferable to use a material having a certain degree of strength. Specific examples include ceramics, such as aluminum oxide, aluminum nitride, silicon nitride, mullite, and the like, and resins, such as phenol resin, epoxy resin, polyimide resin, bismaleimide triazine resin (BT resin), and polyphthalamide (PPA), and the like. The base material may be composed of a semiconductor material, such as silicon and the like, or a conductive material, such as metal and the like. When a semiconductor material, or a conductive material, such as metal and the like is used as the base material, the wirings 31 may be disposed on the surface of the base material via an insulating layer. It is preferable that the wiring board 3 has a good light reflectivity at least near the regions where the first light emitting elements 11-1 and the second light emitting elements 11-2 are mounted.

For example, a metal layer, such as Ag, Al, and the like, or a light reflecting layer using a white resin containing a white pigment or the like may be disposed on the upper surface of the wiring board 3.

The wirings 31 are provided on at least the upper surface of the wiring board 3. Examples of materials of which the wirings 31 are composed include metals, such as Cu, Ag, Au, Al, Pt, Ti, W, Pd, Fe, Ni, and the like, alloys thereof, and the like. Further, for example, when Au is used as a member for joining the wirings 31 with the first light emitting elements 11-1 and the second light emitting elements 11-2, use of Au on the outermost surface of the wirings 31 improves the performance of joining with the first light emitting elements 11-1 and the second light emitting elements 11-2. The terminals 31a for connecting to the outside may be disposed on the lower surface of the wiring board 3, and in this case, the wirings 31 may be provided with relay wirings inside or on the side surfaces of the base material.

Even when mounting a plurality of light emitting elements, the wirings 31 may include two terminals 31a as a pair of wiring patterns, and the plurality of light emitting elements may be connected in series or in parallel between the two terminals 31a.

### Protective Element 4

In the present embodiment, the vehicle light source device 100 includes the protective elements 4, the number of which is a plural number that is the same as the number of the plurality of light emitting elements provided in the vehicle light source device 100. The plurality of protective elements 4 are each electrically connected to a positive electrode and a negative electrodes that drive the first light emitting element 11-1 and the second light emitting element 11-2 individually. The protective elements 4 are, for example, Zener diodes, varistors, resistors, or capacitors. The protective elements 4 are not limited to a configuration in which one protective element 4 is provided correspondingly for each of the first light emitting element 11-1 and the second light emitting element 11-2. For example, as the configuration of the number of protective elements 4 provided in the vehicle light source device 100, one protective element 4 may be provided for each of a plurality of circuits in which every plural number of the first light emitting elements 11-1 and every plural number of the second light emitting elements 11-2 are connected serially, respectively. Further, depending on the application of the vehicle light source device 100 and the form of a module equipped with the vehicle light source device 100, the vehicle light source device 100 does not need to be provided with a protective element.

The vehicle light source device 100 can protect the first light emitting elements 11-1 and the second light emitting elements 11-2 from surge current or electrostatic discharge by including the protective elements 4.

### Modification of Vehicle Light Source Device 100

Hereinafter, a modification of the vehicle light source device 100 will be described. Note that names and reference numerals that are the same as those used in the already described embodiment indicate the same or similar members or configurations, and detailed description thereof will be omitted where appropriate. This similarly applies to the following embodiments.

### First Modification

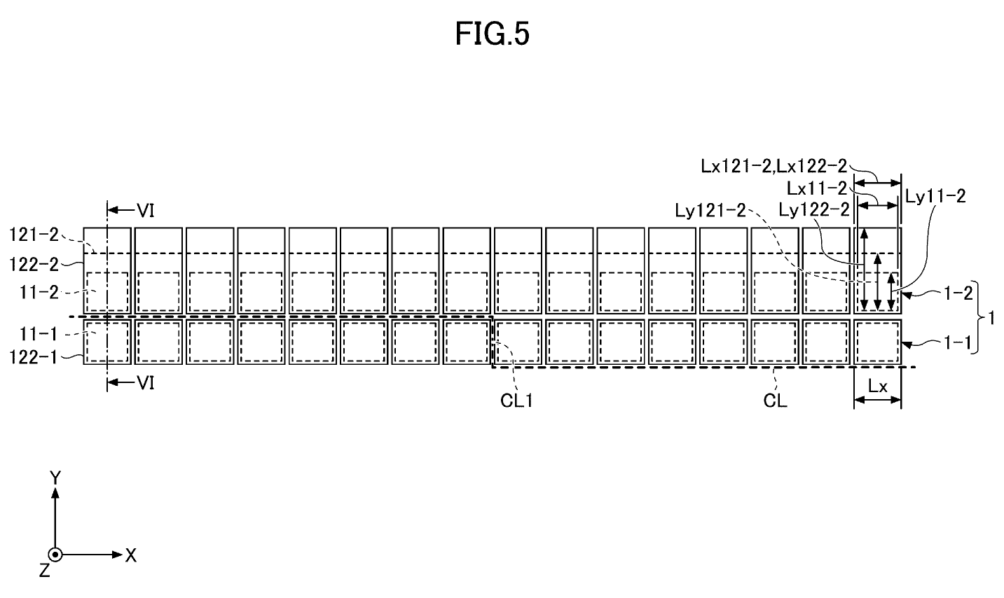

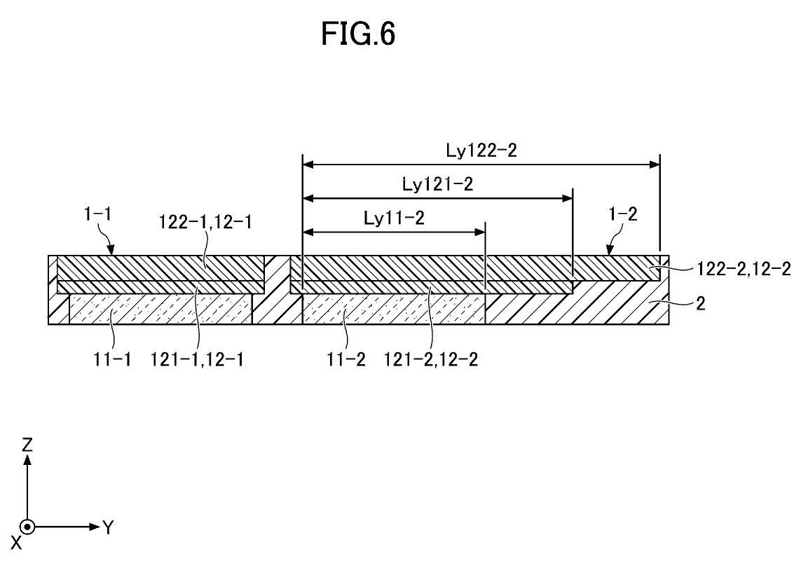

FIG. 5 is a schematic plan view showing a plurality of light sources 1 of the vehicle light source device according to a first modification of the first embodiment. FIG. 6 is a schematic cross-sectional view along a line VI-VI in FIG. 5.

The vehicle light source device according to the first modification differs from the vehicle light source device 100 according to the first embodiment in that the aspect ratio of the second phosphor part 121-2 is greater than that of the second light emitting element 11-2, and the aspect ratio of the second light transmissive part 122-2 is greater than that of the second phosphor part 121-2. The aspect ratio in this specification means the ratio of the length in the column direction Y to the length in the row direction X.

In the example shown in FIGS. 5 and 6, the length Lx11-2 represents the length of the second light emitting element 11-2 in the row direction X. The length Ly11-2 represents the length of the second light emitting element 11-2 in the column direction Y. The length Lx121-2 represents the length of the second phosphor part 121-2 in the row direction X. The length Ly121-2 represents the length of the second phosphor part 121-2 in the column direction Y. The length Lx122-2 represents the length of the second light transmissive part 122-2 in the row direction X. The length Ly122-2 represents the length of the second light transmissive part 122-2 in the column direction Y.

In the row direction X, the length Lx11-2 of the second light emitting element 11-2, the length Lx121-2 of the second phosphor part 121-2, and the length Lx122-2 of the second light transmissive part 122-2 are substantially the same. In the column direction Y, the length Ly121-2 of the second phosphor part 121-2 is greater than the length Ly11-2 of the second light emitting element 11-2. In the column direction Y, the length Ly122-2 of the second light transmissive part 122-2 is greater than the length Ly121-2 of the second phosphor part 121-2. Therefore, the aspect ratio Ly121-2/Lx121-2 of the second phosphor part 121-2 is greater than the aspect ratio Ly11-2/Lx11-2 of the second light emitting element 11-2. The aspect ratio Ly122-2/Lx122-2 of the second light transmissive part 122-2 is greater than the aspect ratio Ly121-2/Lx121-2 of the second phosphor part 121-2.

With the configuration of the vehicle light source device according to the first modification, the same effect as that of the vehicle light source device 100 according to the first embodiment can be obtained. Moreover, as compared with the second example of the vehicle light source device according to the first embodiment shown in FIG. 3B, unevenness of chromaticity in the +Y direction can be reduced.

### Second Modification

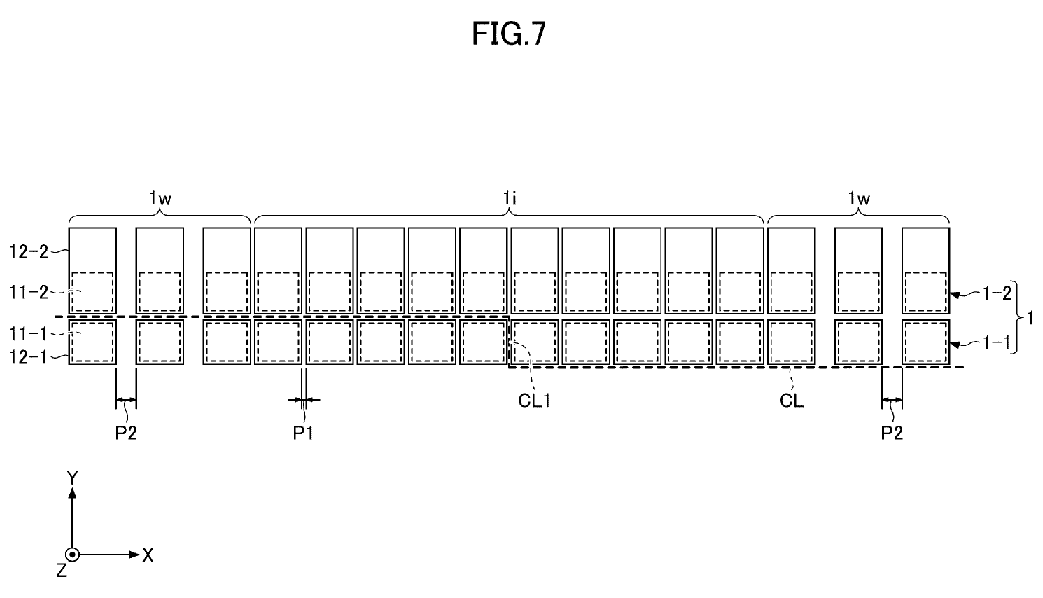

FIG. 7 is a schematic plan view showing a plurality of light sources 1 of the vehicle light source device according to the second modification of the first embodiment.

The vehicle light source device according to the second modification differs from the vehicle light source device 100 according to the first embodiment in that the interval P2 between light sources 1w located on the end sides is greater than the interval P1 between light sources 1i located on the inner side among the intervals between the light sources 1 adjacent to each other in the row direction X.

In FIG. 7, the light sources 1i are light sources included among the light sources 1 of the vehicle light source device according to the second modification and are light source located on the inner side in the row direction X. The interval P1 is the shortest distance between the light sources 1i adjacent to each other in the row direction X among the light sources 1i. On the other hand, the light sources 1w are light sources included among the light sources 1 of the vehicle light source device according to the second modification and are light sources located on the end sides in the row direction X. The end parts in the row direction X are the end parts on the +X side and the -X side. The interval P2 is the shortest distance between light sources 1w adjacent to each other in the row direction X among the light sources 1w. As shown in FIG. 7, in this modification, the interval P2 is greater than the interval P1. For example, the interval P2 can be approximately 2 times to 20 times greater than the interval P1.

For example, when the number of light sources 1 arranged in the row direction X is reduced among the plurality of light sources 1, the total length of the light sources 1 arranged in the row direction X becomes shorter, and the light distribution angle in the row direction X becomes narrower in the irradiation region of the vehicle light source device. As the light distribution angle becomes narrower, the range of emission from the vehicle light source device becomes narrower. On the other hand, when the number of light sources 1 arranged in the row direction X is increased in order to widen the range of emission, the cost of the vehicle light source device increases by the number of light sources 1 added. Therefore, it is required to widen the range of emission while reducing the number of light sources 1 arranged in the row direction X.

In this modification, among the intervals between the light sources 1 adjacent in the row direction X, the interval P2 between the light sources 1w located on the end sides is greater than the interval P1 between the light sources 1i located on the inner side. Thus, it is possible to reduce the number of light sources 1 arranged in the row direction X without shortening the total length of the light sources 1 arranged in the row direction X. Since the total length of the light sources 1 arranged in the row direction X is not shortened, the light distribution angle in the row direction X of a light distribution pattern does not narrow, and the range of emission from the vehicle light source device does not narrow in the irradiation region of the vehicle light source device.

Therefore, in this modification, it is possible to widen the range of emission while reducing the number of light sources 1 arranged in the row direction X.

In this modification, as compared with the vehicle light source device 100 according to the first embodiment, only the interval P2 between the light sources 1w located on the end sides is increased. In the irradiation region corresponding to the light sources 1w located on the end sides, compared with the irradiation region corresponding to the light sources 1i located on the inner side, there are fewer persons who might be dazzled, such as the driver of an oncoming vehicle and the like, and control including minutely dividing regions to be irradiated with light and regions not to be irradiated with light may not be necessary. Therefore, in this modification, by reducing only the divisor by which the region to be irradiated by the light sources 1w located on the end sides is divided, it is possible to exhibit a desired light distribution pattern while reducing the number of light sources 1 mounted.

The effects other than the above-described effects of the vehicle light source device according to this modification are the same as those of the vehicle light source device 100 according to the first embodiment.

### Second Embodiment

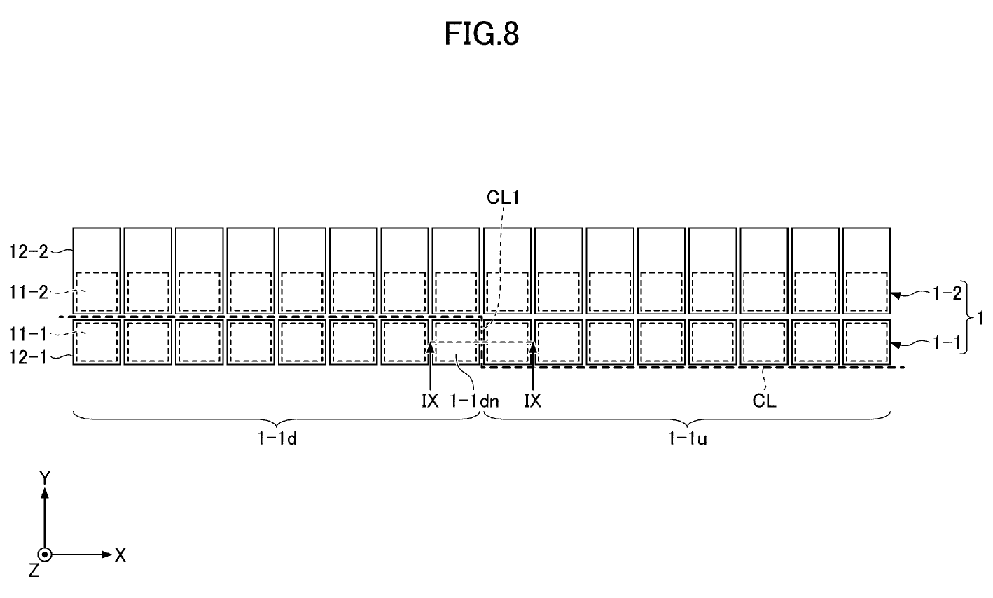

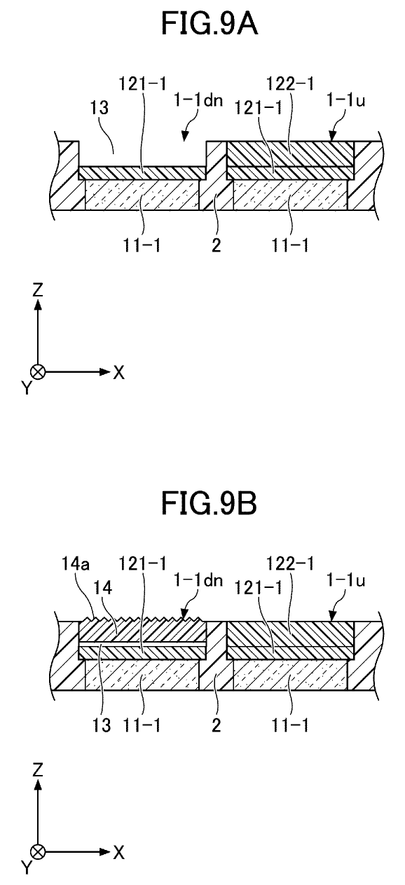

A vehicle light source device according to a second embodiment will be described with reference to FIGS. 8, 9A and 9B. FIG. 8 is a schematic plan view showing a plurality of light sources 1 of the vehicle light source device according to the second embodiment.

In the present embodiment, the plurality of first light sources 1-1 include a plurality of lower first light sources 1-1d arranged adjacent to each other from one end side in the row direction X, and a plurality of upper first light sources 1-1u arranged adjacent to each other from the other end side in the row direction X. The vehicle light source device according to the present embodiment differs from the vehicle light source device 100 according to the first embodiment in that a lower first light source 1-1dn that is located closest to the other end side (i.e., that is located adjacent to the upper first light sources 1-1u arranged from one end side) has a luminance higher than that of the upper first light sources 1-1u.

In the example shown in FIG. 8, one end in the row direction X is an end on the -X side. The other end in the row direction X is an end on the +X side. The lower first light source 1-1dn is the lower first light source 1-1d disposed closest to the other end side. The lower first light source 1-1dn is one lower first light source 1-1d and is located near the center in the row direction X. However, the number of lower first light sources 1-1dn is not limited to one and can be changed appropriately. The position of the lower first light source 1-1dn in the row direction X is not limited to the position near the center and can be changed appropriately. The number of lower first light sources 1-1dn is preferably 4 or greater and 8 or less in order to favorably brighten the region ahead of the vehicle, mounted with the vehicle light source device, in the traveling direction.

The configuration of the lower first light source 1-1dn that can emit light with a luminance higher than that of light emitted by the upper first light sources 1-1u will be described. FIG. 9A is a first example of a schematic cross-sectional view along a IX-IX line in FIG. 8. FIG. 9B is a second example of the schematic cross-sectional view along the IX-IX line in FIG. 8.

In the first example shown in FIG. 9A, the upper first light source 1-1u includes a first light emitting element 11-1, a first phosphor part 121-1 disposed on the first light emitting element 11-1 and containing a first phosphor, and a first light transmissive part 122-1 disposed on the first phosphor part 121-1 and not containing the first phosphor. The lower first light source 1-1dn includes a first light emitting element 11-1, a first phosphor part 121-1 disposed on the first light emitting element 11-1 and containing the first phosphor, and an air layer 13 disposed on the first phosphor part 121-1 and surrounded by the light shielding member 2. That is, in the first example, the lower first light source 1-1dn includes the air layer 13 instead of the first light transmissive part 122-1 of the upper first light source 1-1u. In other words, the vehicle light source device according to the first example has a recess opening to the +Z side and defined by side surfaces composed of the light shielding member 2 and a bottom surface composed of the first phosphor part 121-1 included in the lower first light source 1-1dn.

The lower first light source 1-1dn according to the first example reflects light going in an oblique direction among the light emitted from the first light emitting element 11-1 and going to the +Z side, by the light shielding member 2. Thus, it is possible to reduce the spread of light emitted from the first light emitting element 11-1 in directions over a wide angle. As a result, the lower first light source 1-1dn narrows the light distribution of the light emitted from the first light emitting element 11-1, and can realize light emission with a luminance higher than that achieved by the upper first light source 1-1u.

The second example shown in FIG. 9B differs from the first example shown in FIG. 9A in that the lower first light source 1-1dn is disposed on the air layer 13 and includes a high-luminance light transmissive part 14 including a plurality of projections on an upper surface 14a of the high-luminance light transmissive part 14. For example, the upper surface 14a is a rough surface in which the plurality of projections are provided randomly.

The workings and effects of the air layer 13 are the same as those of the first example shown in FIG. 9A. The high-luminance light transmissive part 14 diffuses light from the first light emitting element 11-1 and light of the light from the first light emitting element 11-1 reflected by the light shielding member 2. Thus, it is possible to reduce the spread of light emitted from the first light emitting element 11-1 in directions over a wide angle. As a result, the lower first light source 1-1dn can narrow the light distribution of the light emitted from the first light emitting element 11-1, and can realize light emission with a luminance higher than that achieved by the upper first light source 1-1u.

The lower first light source 1-1dn that can emit light with a luminance higher than that of light emitted from the upper first light source 1-1u is not limited to the first and second examples described above. For example, the lower first light source 1-1dn can emit light with a high luminance by including two or more laminates in each of which the first semiconductor layer 111a, the light emitting layer 111b, and the second semiconductor layer 111c shown in FIG. 4 are laminated in the normal direction Z. In addition, it is possible to cause the lower first light source 1-1dn to emit light with a higher luminance, by making the value of the drive current higher than that of the upper first light source 1-1u.

The effects of the vehicle light source device according to the second embodiment other than the effects described above are the same as those of the vehicle light source device according to the first embodiment.

### Third Embodiment

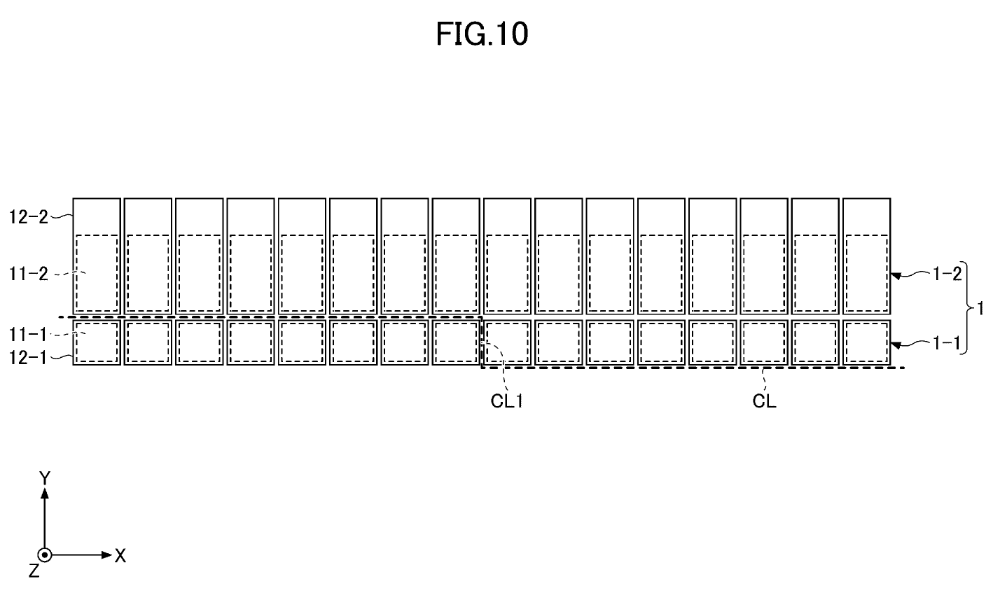

The vehicle light source device according to a third embodiment will be described with reference to FIG. 10. FIG. 10 is a schematic plan view showing a plurality of light sources 1 of the vehicle light source device according to the third embodiment.

The vehicle light source device according to the present embodiment differs from the vehicle light source device 100 according to the first embodiment in that the length of the second light emitting element 11-2 in the column direction Y is greater than that of the first light emitting element 11-1.

In the example shown in FIG. 10, the length of the second light emitting element 11-2 included in each of the plurality of second light sources 1-2 in the column direction Y is greater than the length of the first light emitting element 11-1 included in each of the plurality of first light sources 1-1 in the column direction Y. The second light emitting element 11-2 has an aspect ratio greater than that of the first light emitting element 11-1. The second light transmissive member 12-2 has an aspect ratio greater than that of the second light emitting element 11-2.

With the configuration of the vehicle light source device according to the third embodiment, the same effects as those of the vehicle light source device 100 according to the first embodiment can be obtained. Furthermore, in the high-beam irradiation pattern, it is possible to make the spreading angle of the light distribution pattern to the vertically upper side of the cut-off line CL even greater.

### Fourth Embodiment

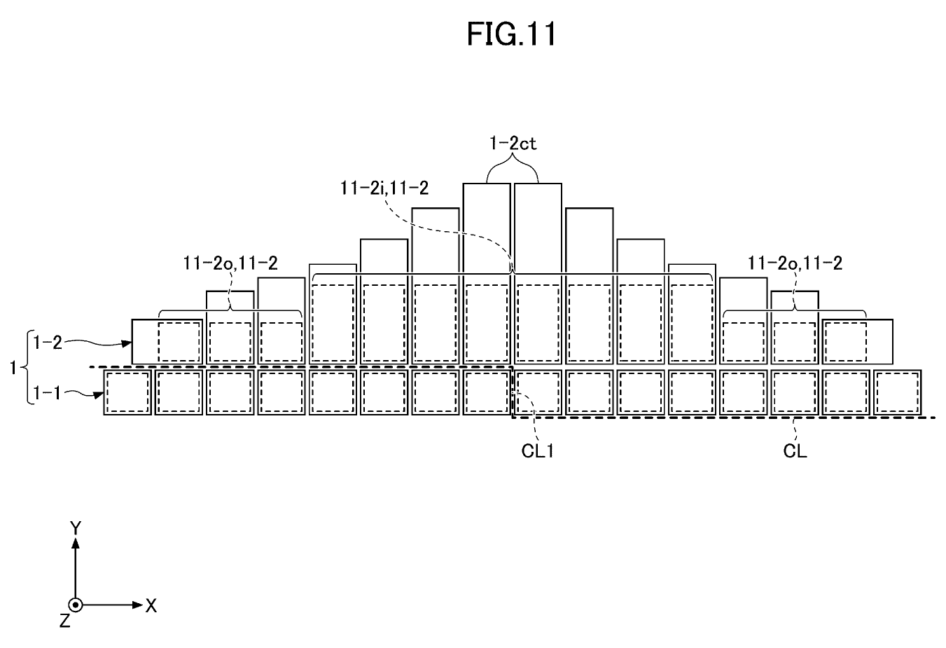

The vehicle light source device according to the fourth embodiment will be described with reference to FIG. 11. FIG. 11 is a schematic plan view showing a plurality of light sources 1 of the vehicle light source device according to a fourth embodiment.

The vehicle light source device according to the present embodiment differs from the vehicle light source device 100 according to the first embodiment in that at least any of the plurality of second light sources 1-2 has an aspect ratio different from that of others.

In the example shown in FIG. 11, among the plurality of second light sources 1-2, two second light sources 1-2ct located in the center in the row direction X have the same aspect ratio. Moreover, among the plurality of second light sources 1-2, the second light sources 1-2ct have the greatest aspect ratio, and the aspect ratios of the second light sources 1-2 gradually decrease from the center to the outer sides in the row direction X. In other words, among the plurality of second light sources 1-2, the second light sources 1-2 located on the inner side in the row direction X have aspect ratios greater than that of the second light sources 1-2 located on the end sides.

In the present embodiment, at least some of the second light sources 1-2 have different aspect ratios. Thus, in the light distribution pattern emitted from the vehicle light source device according to the fourth embodiment, the aspect ratios of the emitted light corresponding to the plurality of second light sources 1-2 can be varied per each of at least some positions in the row direction X.

Among the second light emitting elements 11-2 included in the plurality of second light sources 1-2, a plurality of second light emitting elements 11-2i are a second light emitting elements 11-2 located on the inner side in the row direction X. A plurality of second light emitting elements 11-2o are second light emitting elements 11-2 located on the outer side of the second light emitting elements 11-2i in the row direction X. The aspect ratios of the second light emitting elements 11-2i are equal to each other. The aspect ratios of the second light emitting elements 11-2o are equal to each other. The aspect ratios of the second light emitting elements 11-2i are greater than the aspect ratios of the second light emitting elements 11-2o.

In the present embodiment, among the plurality of second light sources 1-2, second light source 1-2 located on the inner side in the row direction X have aspect ratios greater than the aspect ratios of the second light source 1-2 located on the end sides. Thus, in the light distribution pattern emitted from the vehicle light source device according to the fourth embodiment, it is possible to make the aspect ratios of the irradiated light corresponding to the second light sources 1-2 located on the inner side in the row direction X greater than the aspect ratios corresponding to the second light sources 1-2 located on the end sides. In the vehicle light source device according to the present embodiment, the second light sources 1-2 located on the inner side in the row direction X can mainly irradiate light onto an inner side of a region ahead in the traveling direction (closer to the center). The second light sources 1-2 located on the end sides in the row direction X can mainly irradiate light onto end sides of a region ahead of the traveling direction.

In the present embodiment, among the plurality of second light sources 1-2, at least one second light source 1-2 located on each end side in the row direction X has an aspect ratio that is smaller than 1, that is, has a length in the row direction X that is greater than the length in the column direction Y. As a result, the length of the second light source 1-2 in the row direction X becomes greater on each end side in the row direction X, and a second light emitting element to be disposed on each end side in the row direction X is unnecessary. As a result, in the present embodiment, the greater aspect ratio of the second light sources 1-2 located on the inner side in the row direction X can make the angle, by which the light is spread to the upper side of the region ahead in the traveling direction on a roadway, large in the high-beam irradiation pattern, and can make a traffic sign and the like clearly visible. Furthermore, the smaller aspect ratio of the second light sources 1-2 located on the end sides in the row direction X can reduce light for irradiating the regions on the outer sides of the road to enable reduction in the power consumption, and can reduce adverse effects on surrounding houses and the ecosystem due to excessive irradiation. It is possible to make the length of the light distribution pattern corresponding to the plurality of second light sources 1-2 close to the length of the light distribution pattern corresponding to the plurality of first light sources 1-1 in the irradiation region of the vehicle light source device, while reducing the number of the second light emitting elements in the second light sources 1-2 to be smaller than the number of the first light emitting elements in the first light sources 1-1.

The effects of the vehicle light source device according to the fourth embodiment other than the above-described effects are the same as those of the vehicle light source device according to the first embodiment.

### Fifth Embodiment

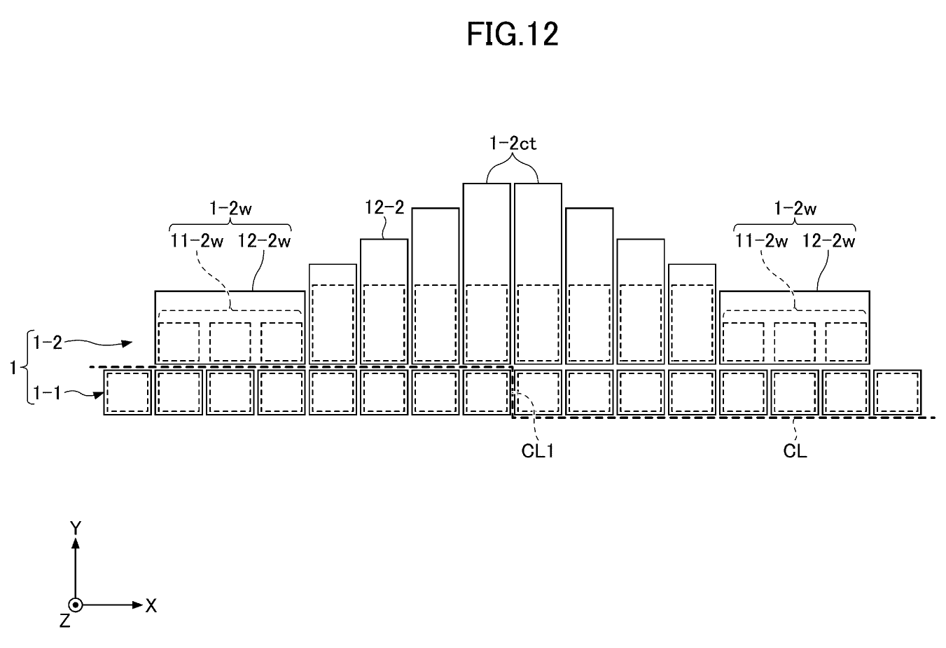

A vehicle light source device according to a fifth embodiment will be described with reference to FIG. 12. FIG. 12 is a schematic plan view showing a plurality of light sources 1 included in the vehicle light source device according to the fifth embodiment.

The vehicle light source device according to the present embodiment differs from the vehicle light source device according to the fourth embodiment in that, among the plurality of second light sources 1-2, a second light source 1-2w located at at least one end in the row direction X includes a plurality of second light emitting elements 11-2w and one second light transmissive member 12-2w disposed across the plurality of second light emitting elements 11-2w.

In the example shown in FIG. 12, each of the second light sources 1-2w located at both ends in the row direction X includes three second light emitting elements 11-2w and one second light transmissive member 12-2w disposed across the three second light emitting elements 11-2w. From another viewpoint, the second light transmissive member 12-2w multifunctionally serves as the second light transmissive member 12-2 for each of the three second light emitting elements 11-2w by being one second light transmissive member 12-2. The aspect ratio of the second light transmissive members 12-2w is smaller than the aspect ratio of the second light emitting elements 11-2 in the second light sources 1-2 other than the second light sources 1-2w among the plurality of second light sources 1-2. In the vehicle light source device according to the fifth embodiment, it is preferable that the three second light emitting elements 11-2w and the three second light emitting elements 11-2w located at both ends in the row direction X are turned on or off simultaneously. Thus, the number of circuits for driving the light sources individually can be reduced.

In the present embodiment, since the second light source 1-2w includes the second light transmissive member 12-2w that collectively covers the plurality of second light emitting elements 11-2w, it is possible to make the length of the light distribution pattern corresponding to the plurality of second light sources 1-2 close to the length of the light distribution pattern corresponding to the plurality of first light sources 1-1 in the irradiation region of the vehicle light source device while reducing the number of the second light transmissive members 12-2 used in the vehicle light source device.

### Sixth Embodiment

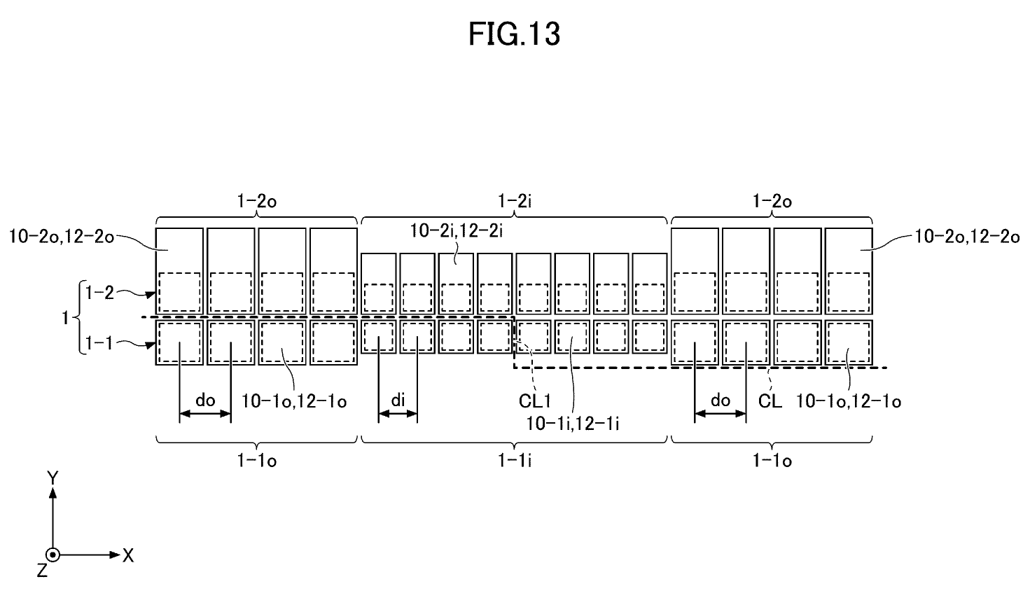

A vehicle light source device according to a sixth embodiment will be described with reference to FIG. 13. FIG. 13 is a schematic plan view showing a plurality of light sources 1 included in the vehicle light source device according to the sixth embodiment.

In the vehicle light source device according to the present embodiment, in the row direction X, light emitting surfaces 10-1i of first light sources 1-1i located on the inner side among the plurality of first light sources 1-1 have an area smaller than the area of light emitting surfaces 10-1o of first light sources 1-1o located on the outer sides. Also, light emitting surfaces 10-2i of second light sources 1-2i located on the inner side among the plurality of second light sources 1-2 have an area smaller than the area of light emitting surfaces 10-2o of second light sources 1-2o located on the outer sides. The vehicle light source device according to the present embodiment differs from the vehicle light source device 100 according to the first embodiment in these respects.

In the example shown in FIG. 13, the number of the first light sources 1-1i and the number of the second light sources 1-2i are each 8. The first light sources 1-1i and the second light sources 1-2i are arranged on the inner side in the row direction X. The number of the first light sources 1-1o and the number of the second light sources 1-2o are each 8. Four first light sources 1-1o are disposed on each of the -X side and the +X side of the first light source 1-1i in the row direction X. Four second light sources 1-2o are disposed on each of the -X side and the +X side of the second light sources 1-2i in the row direction X. The area of the light emitting surface 10-1i is equal to the area of a first light transmissive member 12-1i. The area of the light emitting surface 10-1o is equal to the area of a first light transmissive member 12-1o. The area of the light emitting surface 10-2i is equal to the area of the second light transmissive member 12-2i. The area of the light emitting surface 10-2o is equal to the area of the second light transmissive member 12-2o.

In the present embodiment, since the area of the light emitting surface 10-1i is smaller than the area of the light emitting surface 10-1o, the luminance of the light emitted from the light emitting surface 10-1i is higher than the luminance of the light emitted from the light emitting surface 10-1o. The positions at which the light emitting surfaces 10-1i having the smaller area are disposed can be appropriately changed. However, when the vehicle light source device is used in a vehicle lighting fixture, it is preferable that 4 or more and 8 or less light emitting surfaces 10-1i having the smaller area are disposed on the inner side (for example, in the center) in the row direction X, from the viewpoint of brightly illuminating a region ahead of the vehicle, mounted with the vehicle light source device, in the traveling direction.

In the example shown in FIG. 13, of the intervals between the first light sources 1-1 adjacent to each other in the row direction X, the interval do between the first light sources 1-1o located on the outer sides is greater than the interval di between the first light sources 1-1i located on the inner side. Thus, the vehicle light source device according to the sixth embodiment can select the regions to be irradiated with light or the regions to not be irradiated with light in the irradiation region corresponding to the first light sources 1-1i at a higher definition than in the irradiation regions corresponding to the first light sources 1-1o.

### Seventh Embodiment

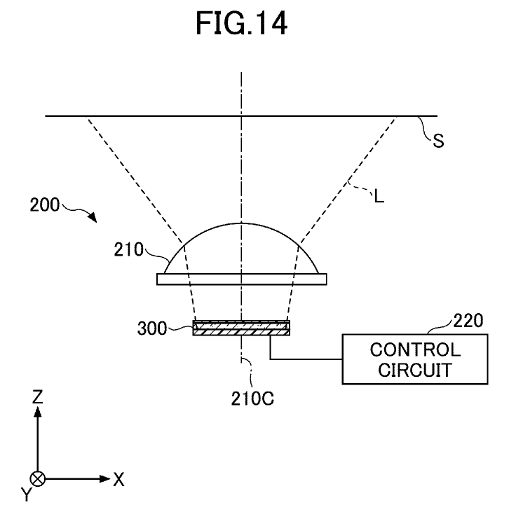

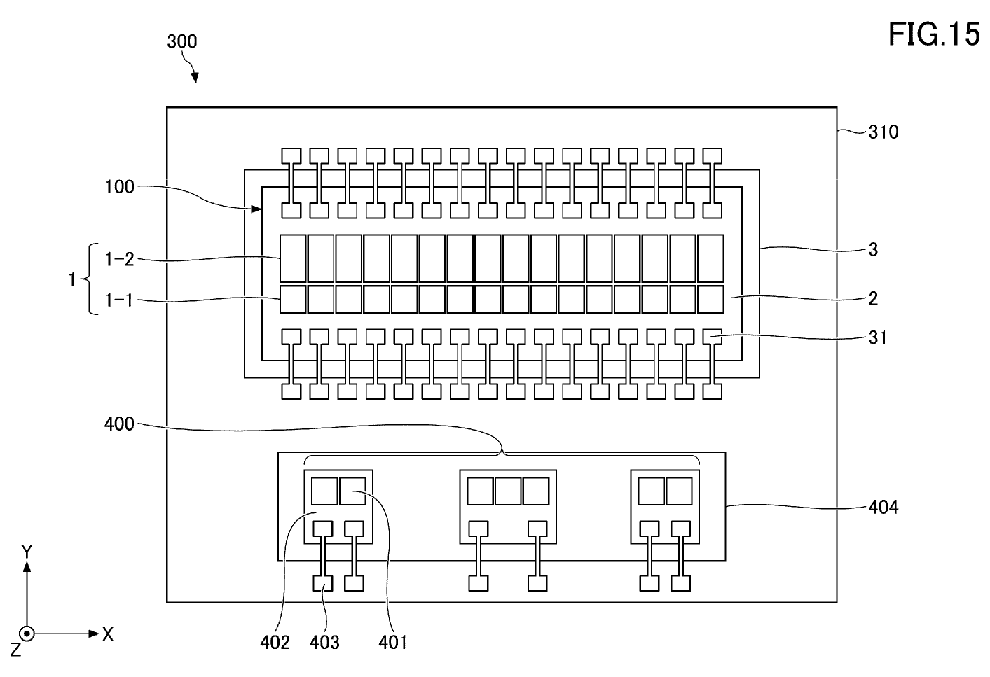

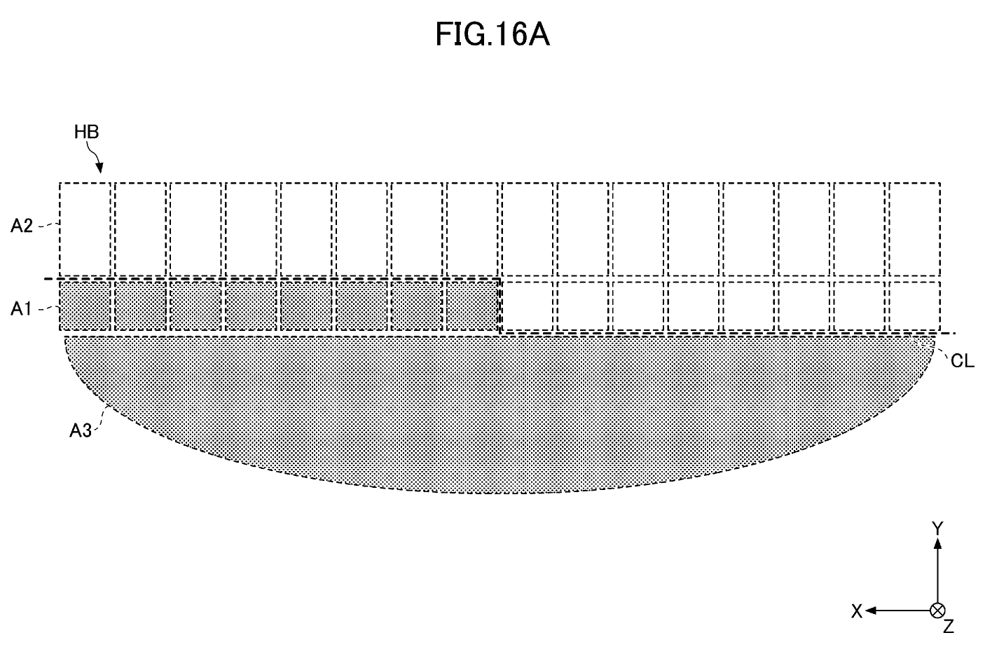

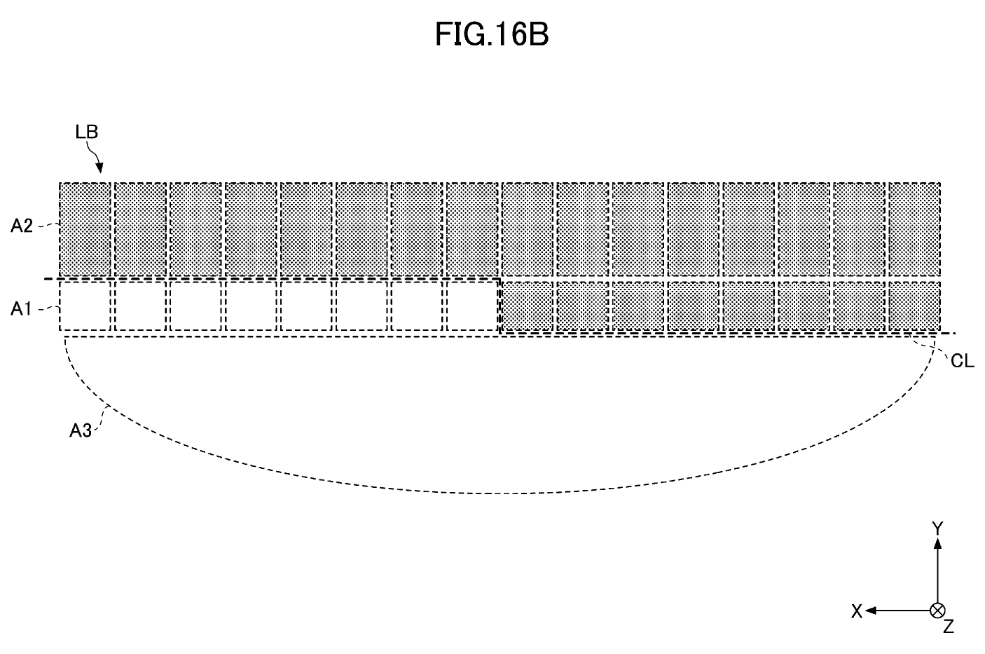

Next, a vehicle lighting fixture according to a seventh embodiment will be described with reference to FIGS. 14, 15, 16A and 16B. FIG. 14 is a schematic cross-sectional view showing the configuration of a vehicle lighting fixture 200 according to the seventh embodiment. FIG. 15 is a schematic view showing a vehicle light source unit 300 of the vehicle lighting fixture 200 according to the seventh embodiment. FIG. 16A is a schematic diagram showing a high-beam light distribution pattern of the vehicle lighting fixture 200 according to the seventh embodiment.

FIG. 16B is a schematic diagram showing a low-beam light distribution pattern of the vehicle lighting fixture 200 according to the seventh embodiment.

As shown in FIG. 14, the vehicle lighting fixture 200 includes the vehicle light source unit 300 and a lens 210 for transmitting light emitted from the vehicle light source unit 300. Further, in the example shown in FIG. 14, the vehicle lighting fixture 200 includes a control circuit 220 capable of individually controlling turning on and off of a plurality of light sources 1 provided in the vehicle light source unit 300. The vehicle lighting fixture 200 can irradiate an irradiation plane S orthogonal to a light axis 210C of the lens 210 with light L transmitted through the lens 210. For example, the vehicle lighting fixture 200 is a headlamp of an automobile. The irradiation plane S is a virtual plane located in front of the vehicle mounted with the vehicle lighting fixture 200.

The lens 210 is a plano-convex single lens of which a surface on the side on which the vehicle lighting fixture 200 is located is a plane, and of which a surface on the side opposite to the side on which the vehicle lighting fixture 200 is located is convex to the side opposite to the side on which the vehicle lighting fixture 200 is located. However, the lens 210 is not limited to a plano-convex single lens, and may be another form, such as a plano-concave single lens, a biconvex single lens, a biconcave single lens, a meniscus single lens, a Fresnel lens, a diffractive lens, a cylindrical lens, and the like. Further, the lens 210 may be a set lens obtained by combining at least one selected from these various lenses.

In the example shown in FIG. 15, the vehicle light source unit 300 includes a vehicle light source device 100, a low-beam light source device 400, and a unit substrate 310 on which the vehicle light source device 100 and the low-beam light source device 400 are disposed.

The vehicle light source device 100 is used to form a high-beam light distribution pattern and a part of a low-beam light distribution pattern. The vehicle light source device 100 includes sixteen first light sources 1-1 and sixteen second light sources 1-2. Any one of the first, second, third, fourth, fifth, or sixth embodiment can be applied as the vehicle light source device 100.

The low-beam light source device 400 is used to form a part of a low-beam light distribution pattern. In the example shown in FIG. 15, the low-beam light source device 400 includes a plurality of low-beam light sources 401 and a low-beam light shielding member 402 holding the plurality of low-beam light sources 401 collectively. The low-beam light source device 400 also includes a low-beam wiring board 404 including low-beam wirings 403 electrically connected to the plurality of low-beam light sources 401. The low-beam light source device 400 may further include a protective element or the like that is disposed on the low-beam wiring board 404 and covered with the low-beam light shielding member 402.

The plurality of low-beam light sources 401 include seven low-beam light sources 401 arranged in the row direction X. The seven low-beam light sources 401 include three low-beam light sources 401 arranged in the center in the row direction X and two low-beam light sources 401 arranged on the -X side at a distance from the center three low-beam light sources 401. The seven low-beam light sources 401 include two low-beam light sources 401 arranged on the +X side at a distance from the center three low-beam light sources 401.

The control circuit 220 shown in FIG. 14 is electrically connected to each of the plurality of light sources 1 of the vehicle lighting fixture 200 and each of the plurality of low-beam light sources 401 of the low-beam light source device 400. The control circuit 220 includes a processor, an electronic circuit, a memory, and the like. The processor is a Central Processing Unit (CPU) or the like. The electronic circuit is an Application Specific Integrated Circuit (ASIC), a Field Programmable Gate Array (FPGA), or the like.

The memory is a Read Only Memory (ROM), a Random Access Memory (RAM), a Hard Disk Drive (HDD), a Solid State Drive (SSD), or the like.

The light L emitted from the vehicle lighting fixture 200 has a light distribution corresponding to the plurality of light sources 1 and the plurality of low-beam light sources 401 provided in the vehicle light source unit 300. The vehicle lighting fixture 200 can perform lighting control individually on the sixteen first light sources 1-1 and the sixteen second light sources 1-2 of the vehicle light source device 100, and on the low-beam light source device 400 via the control circuit 220. The vehicle lighting fixture 200 can emit either the high-beam light distribution pattern HB shown in FIG. 16A or the low-beam light distribution pattern LB shown in FIG. 16B as the light distribution pattern of the light L.

The high-beam light distribution pattern HB shown in FIG. 16A includes regions A1 corresponding to the sixteen first light sources 1-1, regions A2 corresponding to the sixteen second light sources 1-2, and a region A3 corresponding to the low-beam light source device 400 in the irradiation region of the vehicle lighting fixture 200. Similarly, the low-beam light distribution pattern LB shown in FIG. 16B includes regions A1 corresponding to the sixteen first light sources 1-1, regions A2 corresponding to the sixteen second light sources 1-2, and a region A3 corresponding to the low-beam light source device 400 in the irradiation region of the vehicle lighting fixture 200. In FIGS. 16A and 16B, the regions that are not irradiated with light due to the light sources being turned off are represented by a dot pattern, and the regions that are irradiated with light due to the light sources being turned on are represented without a dot pattern.

In the high-beam light distribution pattern HB shown in FIG. 16A, sixteen regions A2 corresponding to the sixteen second light sources 1-2 and eight regions A1 corresponding to eight first light sources 1-1 located above the cut-off line CL among the sixteen first light sources 1-1 are irradiated with light. On the other hand, in the low-beam light distribution pattern LB shown in FIG. 16B, eight regions A1 corresponding to eight first light sources 1-1 located below the cut-off line CL among the sixteen first light sources 1-1 and the region A3 corresponding to the low-beam light source device 400 are irradiated with light.

In the present embodiment, it is possible to provide the vehicle lighting fixture 200 that, by including the vehicle light source device 100, capable of realizing a function suitable for a headlamp of the adaptive driving beam (ADB) type that controls light distribution depending on the surrounding environment. In addition, by including the control circuit 220, the vehicle lighting fixture 200 can realize the adaptive driving beam function in high-beam irradiation. The vehicle lighting fixture 200 can reduce dazzle (glare) that might be given to the driver of the preceding vehicle or the oncoming vehicle of the vehicle mounted with the vehicle lighting fixture 200 by the adaptive driving beam function.

### Eighth Embodiment

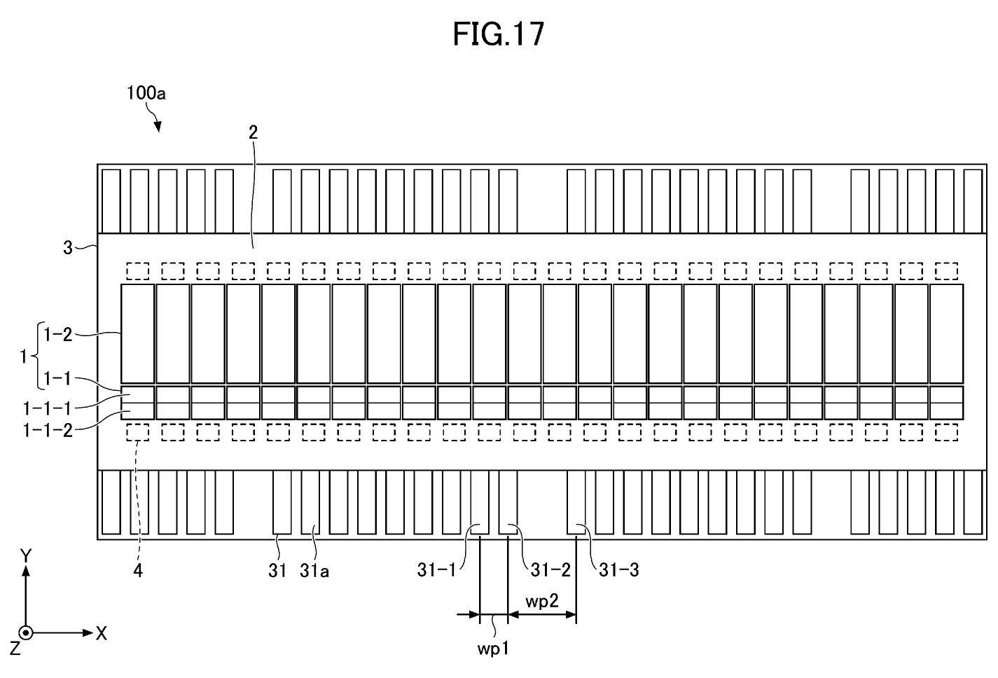

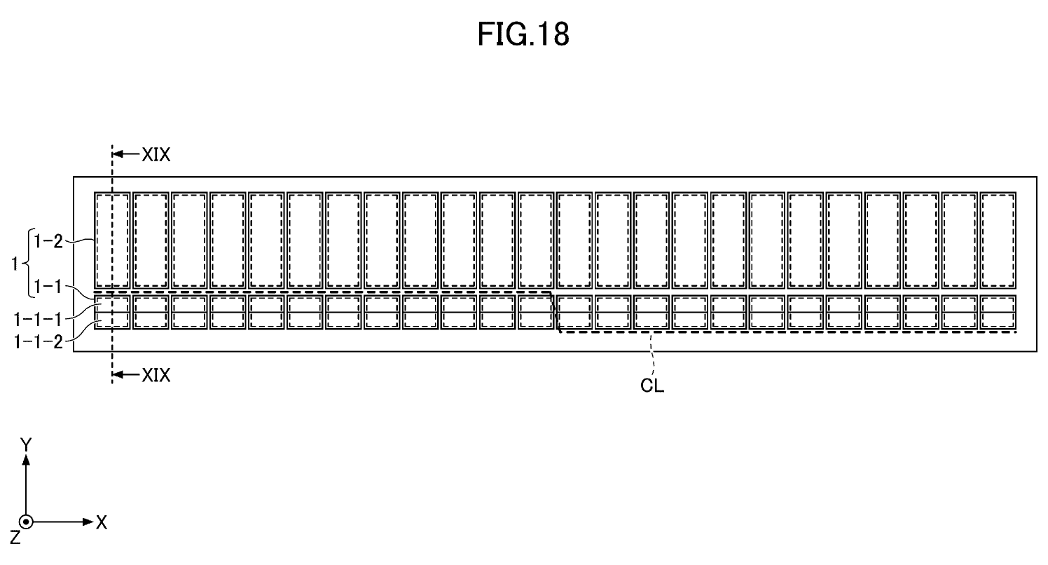

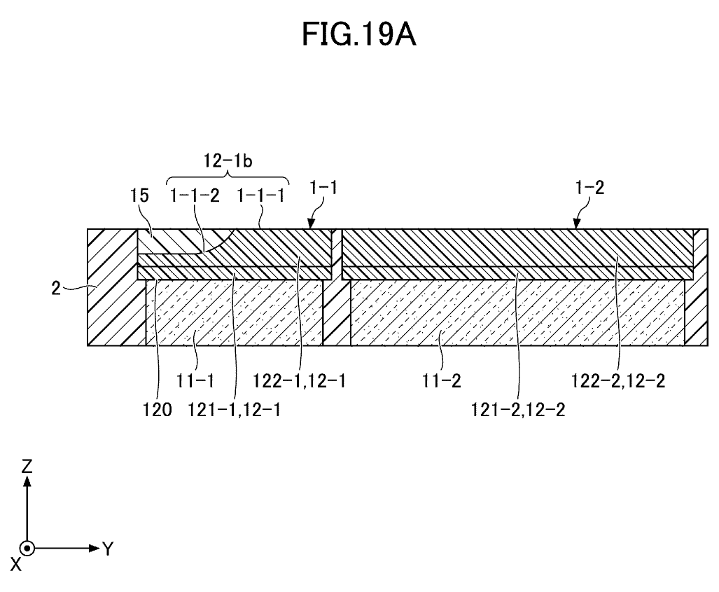

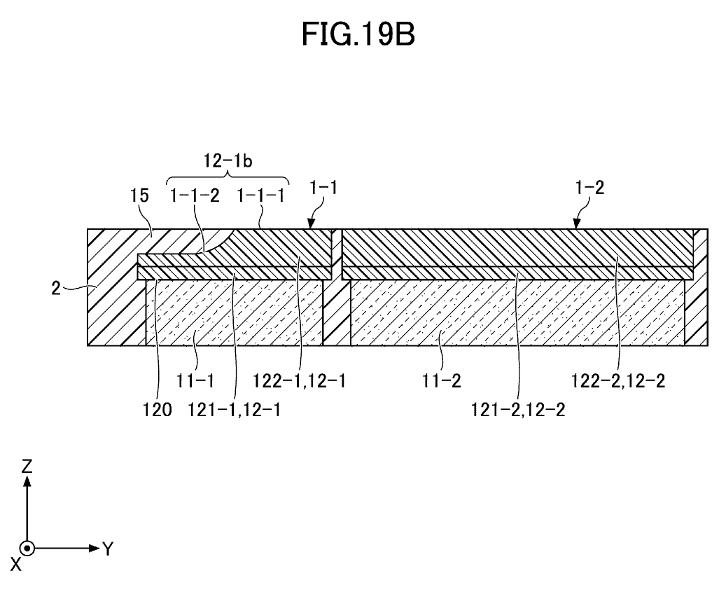

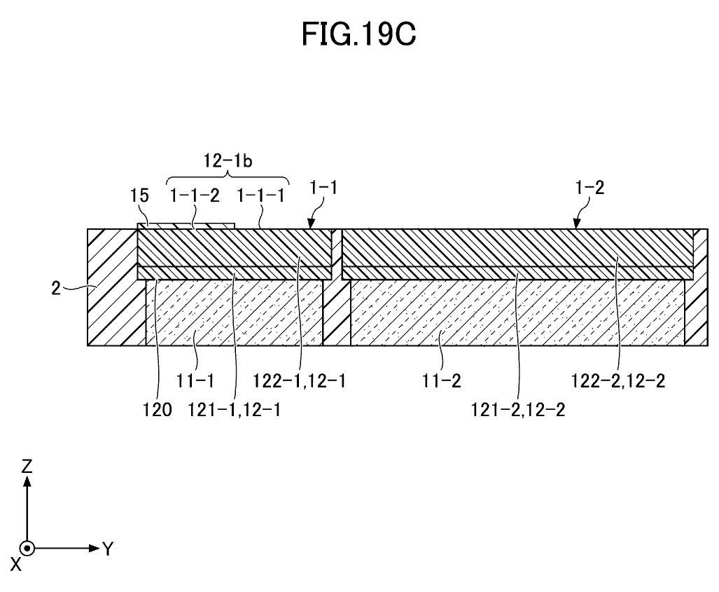

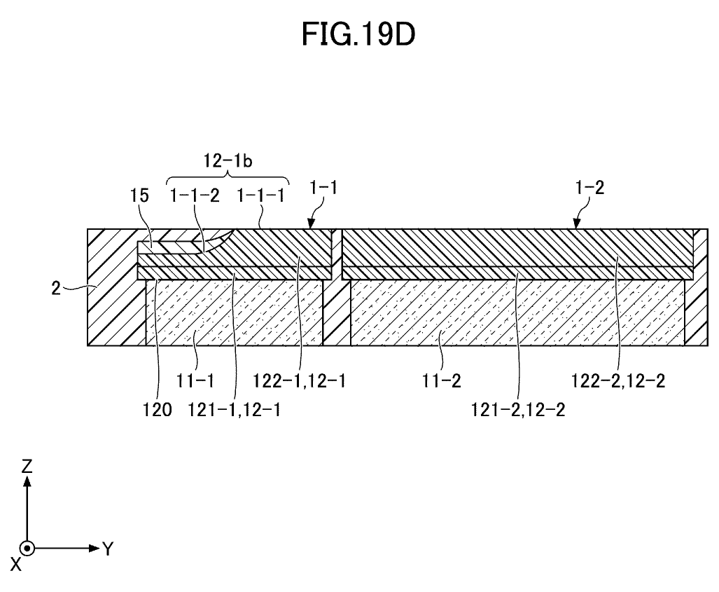

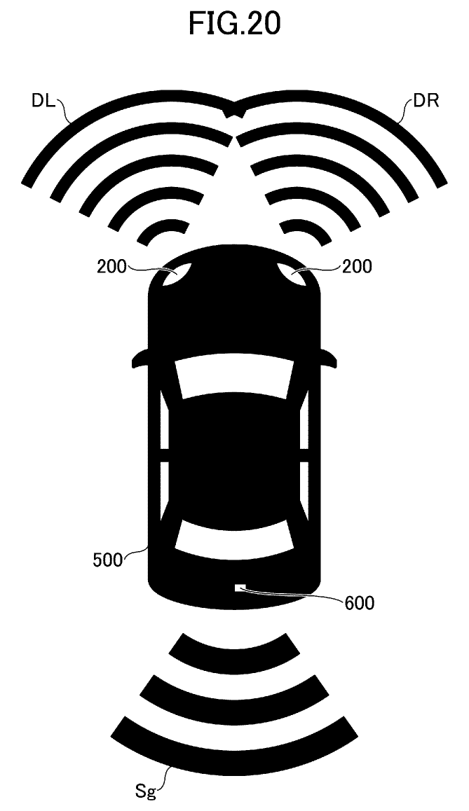

Next, a vehicle light source device according to an eighth embodiment will be described with reference to FIGS. 17, 18, 19A, 19B, 19C, and 19D. FIG. 17 is a schematic plan view showing the overall configuration of a vehicle light source device 100a according to the eighth embodiment. FIG. 18 is a schematic plan view showing a plurality of light sources 1 included in the vehicle light source device 100a. FIGS. 19A, 19B, 19C, and 19D are schematic cross-sectional views along an XIXA-XIXA line of FIG. 18. FIG. 19A is a first example, FIG. 19B is a second example, FIG. 19C is a third example, and FIG. 19D is a fourth example.

In the vehicle light source device 100a, the upper surface 12-1b of the first light transmissive member 12-1 of the first light source 1-1 includes a first upper surface region 1-1-1 adjacent to the second light source 1-2, and a second upper surface region 1-1-2 located on a side of the first upper surface region 1-1-1 opposite to the second light source 1-2. The first light source 1-1 further includes a light reflecting member 15 disposed in the second upper surface region 1-1-2. The vehicle light source device 100a differs from the vehicle light source device 100 according to the first embodiment in the above respects.

As shown in FIGS. 17 and 18, the second upper surface region 1-1-2 is a region located on the -Y side of the first upper surface region 1-1-1. From another viewpoint, the second upper surface region 1-1-2 is a region located on the vertically lower side of the first upper surface region 1-1-1 when the vehicle light source device 100a is used.

As shown in FIGS. 19A, 19B, 19C and 19D, the light reflecting member 15 is disposed in the second upper surface region 1-1-2 in the Z direction. The light reflecting member 15 may be disposed in the second upper surface region 1-1-2 such that the position of the first upper surface region 1-1-1 and the position of the second upper surface region 1-1-2 in the Z direction coincide with each other, or may be disposed such that the position of the first upper surface region 1-1-1 and the position of the second upper surface region 1-1-2 in the Z direction are different. However, the position of the first upper surface region 1-1-1 and the position of the second upper surface region 1-1-2 in the Z direction do not need to coincide. For example, when the light reflecting member 15 is a reflective film formed on the upper surface 12-1b, the position of the first upper surface region 1-1-1 may be shifted in the Z direction from the position of the second upper surface region 1-1-2 by the thickness of the reflective film.

The light reflecting member 15 reflects at least a part of the light incident from the first light emitting element 11-1. At least a part of the light reflected by the light reflecting member 15 is guided through the first light transmissive part 122-1 to be extracted via the first upper surface region 1-1-1. In other words, in the vehicle light source device 100a, of the light emitted from the first light emitting element 11-1, light that is reflected by the light reflecting member 15 and reaches the first upper surface region 1-1-1 and light that reaches the first upper surface region 1-1-1 without via the light reflecting member 15 are collectively extracted via the first upper surface region 1-1-1.

Here, the vehicle light source device 100a can emit the light emitted from the first light sources 1-1 located on the -Y side of the cut-off line CL shown in FIG. 18 among the plurality of first light sources 1-1 as a low-beam light distribution pattern of a headlight. When the vehicle light source device 100a emits the low-beam light distribution pattern, the illuminance might become higher than necessary in a region in which a part of the light emitted from the vehicle light source device 100a and a part of light emitted from a low-beam light source device other than the vehicle light source device 100a overlap each other. As a result, light having a luminance higher than that of light emitted to the vicinity of the cut-off line is emitted to the vertically below the cut-off line. Specifically, as the low-beam of the headlight, light having a luminance higher than necessary is emitted to the road on the front side of the vehicle on the driving lane, which may cause dazzle or glare.

The vehicle light source device 100a can cause the light emitted from the first light emitting element 11-1 of the first light source 1-1 to be extracted via the first upper surface region 1-1-1 by reflecting the light on the light reflecting member 15. Thus, light to be extracted via the second upper surface region 1-1-2 is reduced, and light to be extracted via the first upper surface region 1-1-1 can be increased. As light to be extracted via the second upper surface region 1-1-2 is reduced, when the vehicle light source device 100a emits the low-beam light distribution pattern, the illuminance in the region in which a part of the light emitted from the vehicle light source device 100a and a part of the light emitted from the low-beam light source device overlap each other is reduced. As a result, dazzle, glare, or the like that may be given to the driver of the vehicle mounted with the vehicle light source device 100a and the driver of an oncoming vehicle is likely to be reduced. Further, by increasing the light to be emitted from the first upper surface region 1-1-1, the vehicle light source device 100a can irradiate the vicinity of the cut-off line CL with light having a high luminance and brightly illuminate the vicinity of the cut-off line CL.

The luminance of the light emitted from the second upper surface region 1-1-2 is preferably equal to or greater than 0% and equal to or less than 50% the luminance of the light emitted from the first upper surface region 1-1-1. As a result, when the vehicle light source device 100a emits the low-beam light distribution pattern, the emitted light luminance in the region in which part of the light emitted from the vehicle light source device 100a and a part of the light emitted from the low-beam light source device overlap each other is further reduced, making dazzle, glare, or the like more likely to be reduced.

It is preferable that the second upper surface region 1-1-2 includes an inclined region that is inclined such that the light is directed in the +Z direction as it is directed in the +Y direction, in order for the light reflected by the light reflecting member 15 to be directed toward the first upper surface region 1-1-1. From another viewpoint, in the Z direction, it is preferable that the distance from the second upper surface region 1-1-2 to a lower surface 120 of the first light transmissive member 12-1 is less than the distance from the first upper surface region 1-1-1 to the lower surface 120 of the first light transmissive member 12-1. For example, in the first example shown in FIG. 19A, the second example shown in FIG. 19B, and the fourth example shown in FIG. 19D, in the Z direction, the distance from the second upper surface region 1-1-2 to the lower surface 120 of the first light transmissive member 12-1 is less than the distance from the first upper surface region 1-1-1 to the lower surface 120 of the first light transmissive member 12-1. This configuration enables the light emitted from the first light emitting element 11-1 and reflected by the light reflecting member 15 to be efficiently extracted via the first upper surface region 1-1-1 through the first light transmissive member 12-1.

In the vehicle light source device 100a, among the plurality of first light sources 1-1 arranged in the X direction, the first light sources 1-1 located on the -Y side of the cut-off line CL can be used for emission of the low-beam light distribution pattern. In the example shown in FIG. 18, among twenty-four first light sources 1-1 arranged in the X direction, twelve first light sources 1-1 located on the -X side are used for emission of the low-beam light distribution pattern. In this case, when the vehicle light source device 100a emits the low-beam light distribution pattern in a country where a driving lane is on the right side of a road, that is, in a country where the traffic moves on the right, the effects of reducing dazzling, glaring, or the like on the oncoming lane located on the left side of the driving lane and enabling illuminating the vicinity of the cut-off line CL brightly are obtained.

On the other hand, the driving lane of automobiles on the roads differs depending on the countries. In a country with left-hand traffic, the oncoming lane is on the right side. Therefore, for example, when the vehicle light source device 100a is used in a country with left-hand traffic, it is preferable to reduce dazzling, glaring, or the like on the oncoming lane located on the right side of the driving lane and to brightly illuminate the vicinity of the cut-off line CL.

As shown in FIG. 18, in the vehicle light source device 100a, the upper surface 12-1b of the first light transmissive member 12-1 may include the first upper surface region 1-1-1 and the second upper surface region 1-1-2 in all of the plurality of first light sources 1-1 arranged in the X direction. This enables the first light sources 1-1 that are to be used for emitting the low-beam light distribution pattern to be varied between the case where the vehicle light source device 100a is used in a country with right-hand traffic and the case where it is used in a country with left-hand traffic. Specifically, when the vehicle light source device 100a is used in a country with right-hand traffic, twelve first light sources 1-1 located on the -X side among the twenty-four first light sources 1-1 are used for emitting the low-beam light distribution pattern. On the other hand, when the vehicle light source device 100a is used in a country with left-hand traffic, twelve first light sources 1-1 located on the +X side among the twenty-four first light sources 1-1 are used for emitting the low-beam light distribution pattern. As a result, regardless of whether the vehicle light source device 100a is used in a country with right-hand traffic or in a country with left-hand traffic, it is possible to reduce dazzling, glaring, or the like of the oncoming lane, and to brightly illuminate the vicinity of the cut-off line CL. As the number of the first light sources 1-1 used for emitting the low-beam light distribution pattern, any number that is in a range of 1 or greater and 11 or less may be used depending on the combination with optical parts and the like used in the vehicle lighting fixture, and the like.

In the example shown in FIGS. 17 and 18, in the X direction, the lengths of the first upper surface region 1-1-1 and the second upper surface region 1-1-2 are substantially equal to each other, and are substantially equal to the length of the upper surface 12-1b of the first light transmissive member 12-1. In the Y direction, the lengths of the first upper surface region 1-1-1 and the second upper surface region 1-1-2 are substantially equal to each other, and is substantially half the length of the upper surface 12-1b of the first light transmissive member 12-1. The lengths of the first upper surface region 1-1-1 and the second upper surface region 1-1-2 in the X direction and/or the lengths of the first upper surface region 1-1-1 and the second upper surface region 1-1-2 in the Y direction may be different from each other.

For example, from the viewpoint of improving the illuminance in the vicinity of the cut-off line CL, the area of the first upper surface region 1-1-1 may be equal to or less than 50% the area of the lower surface 120 of the first light transmissive member 12-1. Specifically, by making the length of the first upper surface region 1-1-1 in the Y direction equal to the length of the second upper surface region 1-1-2 or shorter than the length of the second upper surface region 1-1-2, it is possible to further improve the luminance of the light emitted from the first upper surface region 1-1-1. It is preferable that the lengths of the first upper surface region 1-1-1 and the second upper surface region 1-1-2 in the X direction are equal to each other in consideration of the spread of light in the horizontal direction.

In the example shown in FIGS. 17 and 18, the plan view shapes of all of the first upper surface regions 1-1-1 are the same rectangular shapes. However, the plan view shapes of the first upper surface regions 1-1-1 are not limited to rectangles, and may be other shapes, such as trapezoids and the like.

In the plurality of first light sources 1-1 provided in the vehicle light source device 100a, the plan view shapes of all of the first upper surface regions 1-1-1 may be the same shape or some of them may have different shapes. For example, by making the area of the first upper surface region gradually decrease from the outer side to the inner side, it is possible to further increase the luminance of the light with which the inner side (closer to the center) of a region ahead in the traveling direction is irradiated.

In the examples shown in FIGS. 19A, 19B, 19C and 19D, the first upper surface region 1-1-1 is the upper surface of the first light transmissive part 122-1 of the first light transmissive member 12-1. The light reflecting member 15 reflects at least a part of the light emitted from the first light emitting element 11-1 and become incident toward the light reflective member 15 through the first phosphor part 121-1. At least a part of the light reflected by the light reflecting member 15 is extracted via the first upper surface region 1-1-1. That is, of the light emitted from the first light emitting element 11-1, the light reflected by the light reflecting member 15 and light that does not become incident toward the light reflecting member 15 and reaches the first upper surface region 1-1-1 through the first phosphor part 121-1 are collectively extracted via the first upper surface region 1-1-1.

In the first example shown in FIG. 19A, the light reflecting member 15 is a member to which light reflectivity is imparted by adding particles of a light reflecting material in a matrix material, such as a resin, a ceramic, or the like, to form a white member. Examples of the resin include epoxy resin, silicone resin, and the like. Examples of the ceramic include aluminum nitride, silicon nitride, aluminum oxide, silicon carbide, and the like. Examples of the light reflecting material include titanium oxide, silicon oxide, zirconium oxide, aluminum oxide, magnesium oxide, calcium carbonate, calcium hydroxide, calcium silicate, zinc oxide, barium titanate, potassium titanate, aluminum nitride, boron nitride, and mullite, combinations thereof, and the like. Among them, titanium oxide is preferable because it is relatively stable with respect to moisture and the like and has a high refractive index. In the first example shown in FIG. 19A, the light reflecting member 15 and the light shielding member 2 are different members made of different materials.

In the second example shown in FIG. 19B, the light reflecting member 15 is formed integrally with the light shielding member 2 located on the -Y side of the light reflecting member 15. The light reflecting member 15 and the light shielding member 2 are made of the same material. The light reflecting member 15 and the light shielding member 2 are made of the same materials as the materials of which the light reflecting member 15 in the first example is made.

In the third example shown in FIG. 19C, the light reflecting member 15 is a reflective film provided on the upper surface of the first light transmissive member 12-1. The reflective film is, for example, a metal film containing aluminum, gold, or the like, or a dielectric multilayer film containing titanium oxide, silicon oxide, magnesium fluoride, or the like.

In the fourth example shown in FIG. 19D, the light reflecting member 15 includes a part formed integrally with the light shielding member 2 located on the -Y side of the light reflecting member 15, and a part formed as a separate member from the light shielding member 2. In the part of the light reflecting member 15 that is formed integrally with the light shielding member 2, the light reflecting member 15 and the light shielding member 2 are made of the same materials. On the other hand, in the part of the light reflecting member 15 that is formed as a member separate from the light shielding member 2, the light reflecting member 15 is made of materials different from the materials of the light shielding member 2. The part that is formed as a member separate from the light shielding member 2 can be made of the same materials as those cited in the first example and/or the second example.

The light emission drive circuits for the plurality of light sources 1 included in the vehicle light source device 100a are configured to be able to drive light emission per group including various numbers of light sources 1. For example, the vehicle light source device 100a can drive light emission per group including eight light sources 1, per group including twelve light sources 1, and per group including sixteen light sources 1. By being able to perform light emission drive per group including various numbers of light sources 1, it is possible to improve the latitude of selection of an LED matrix manager that is used for efficiently managing the currents of a matrix light or a pixel light.

In the example shown in FIG. 17, the vehicle light source device 100a includes a wiring board 3 including a plurality of wirings 31. In the vehicle light source device 100a, the wiring board 3 includes wirings 31, some of which are varied in pitch with respect to an adjacent wiring 31. Here, the pitch with respect to an adjacent wiring 31 means the shortest distance between a plurality of wirings 31 exposed from the light shielding member 2 on the upper surface of the vehicle light source device 100a. For example, among the plurality of wirings 31 exposed from the light shielding member 2 on the upper surface of the vehicle light source device 100a, a wiring pitch wp1 between a wiring 31-1 and a wiring 31-2 is different from a wiring pitch wp2 between the wiring 31-2 and a wiring 31-3. The wiring pitch wp1 is shorter than the wiring pitch wp2. The wiring pitch wp1 is the pitch between the wirings 31 used for driving light emission of the light source 1 belonging to the same group. The wiring pitch wp2 is the pitch between the wirings 31 used for driving light emission of the light sources 1 belonging to different groups. When some adjacent wirings 31 are varied in pitch, occurrence of migration is likely to be reduced.

The effects of the vehicle light source device 100a other than those described above are the same as those of the vehicle light source device 100 according to the first embodiment.

### Ninth Embodiment

Next, a vehicle according to a ninth embodiment will be described with reference to FIG. 20. FIG. 20 is a schematic view showing an example of the overall configuration of a vehicle 500 according to the ninth embodiment. FIG. 20 shows the vehicle 500 viewed from vertically upper side.

The vehicle 500 includes the vehicle lighting fixture 200. In the example shown in FIG. 20, the vehicle 500 includes a sensor 600.

In the vehicle 500, at least one vehicle lighting fixture 200 is arranged on each of the right front part of the vehicle 500 and the left front part of the vehicle 500. The vehicle lighting fixture 200 arranged on the right front part of the vehicle 500 emits light having a light distribution DR. The vehicle lighting fixture 200 arranged on the left front part of the vehicle 500 emits light having a light distribution DL. The same two vehicle lighting fixtures 200 may be arranged on the vehicle 500 with the same orientation, or the same two vehicle lighting fixtures may be arranged on the vehicle 500 with the orientations reversed from each other left and right. When they are arranged in the same orientation, the light distribution DR and the light distribution DL are the same. When they are arranged in the orientations reversed from each other left and right, the light distribution DR and the light distribution DL are the reverses from each other left and right. The vehicle lighting fixtures 200 arranged on the left front part and the right front part of the vehicle 500 may have the same structure, or may have a bilaterally symmetrical structure. The vehicle 500 may have one vehicle lighting fixture 200 on either the right front part or the left front part of the vehicle 500.

The sensor 600 outputs information about the external environment as an output signal Sg. The sensor 600 is, for example, a camera that outputs an output signal Sg corresponding to a photographed image of the surroundings of the vehicle 500. Alternatively, the sensor 600 may be a GPS sensor that outputs position information of a Global Positioning System (GPS) and the like from a Global Navigation Satellite System (GNSS) as an output signal Sg.

Furthermore, the sensor 600 may be a speedometer that measures the traveling speed of the vehicle 500 and outputs information about the traveling speed as an output signal Sg. The traveling speed of the vehicle 500 includes the relative speed with respect to a vehicle other than the vehicle 500. The traveling speed of the vehicle 500 is applicable as the output signal Sg from the viewpoint that it is the relative speed with respect to the road existing outside the vehicle 500 or a vehicle other than the vehicle 500. The sensor 600 may output information other than those described above as the output signal Sg. The output signal Sg is input into the control circuit 220 provided in the vehicle lighting fixture 200.

The vehicle 500 according to the present embodiment can realize the ADB function by the control circuit 220 performing the lighting control of the vehicle light source device 100 based on the output signal Sg from the sensor 600. By the ADB function, the vehicle 500 can prevent the driver of the preceding vehicle or the oncoming vehicle of the vehicle 500 from being dazzled.

Although the preferred embodiments have been described in detail above, the above-described embodiments are non-limiting, and various modifications and substitutions are applicable to the above-described embodiments without departing from the scope of descriptions in the claims.

All numerical values, such as ordinal numbers and quantities, used in the description of the embodiments are exemplified for the purpose of concretely explaining the technology of the present disclosure, and the present disclosure is not limited to the exemplified numerical values. Furthermore, the connection relationship between the components is exemplified for the purpose of concretely explaining the technology of the present disclosure, and the connection relationship for realizing the function of the present disclosure is not limited thereto.

Because the light emitting device and the vehicle lighting fixture of the present disclosure have a light distribution in which some parts have a higher luminosity, they can be suitably used for applications in which they are mounted on vehicles, such as automobiles and the like. In particular, the light emitting device and the vehicle lighting fixture of the present disclosure can be suitably used as a lighting fixture for automobiles.

In the embodiments described above, examples in which the vehicle light emitting device and the vehicle lighting fixture are headlights are described, but the vehicle light emitting device and the vehicle lighting fixture of the present disclosure are not limited thereto. For example, the vehicle light emitting device and the vehicle lighting fixture can be used for various applications, such as communication lamps and daytime running lamps, and the like. Moreover, the vehicle light emitting device and the vehicle lighting fixture of the present disclosure are not limited to the automobile installation application. The vehicle light emitting device and the vehicle lighting fixture of the present disclosure may be used not only as vehicle lighting fixtures, but also as lighting fixtures for aircraft, such as helicopters, drones, and the like.

What is claimed is:

1. A vehicle light source device comprising:
a plurality of light sources arranged in two rows and n columns, wherein n is a natural number of 4 or greater, the plurality of light sources including:
a plurality of first light sources arranged in a row direction in a first row, each of the first light sources comprising a first light emitting element and a first light transmissive member arranged on the first light emitting element, and
a plurality of second light sources arranged in the row direction in a second row, each of the second light sources comprising a second light emitting element and a second light transmissive member arranged on the second light emitting element; wherein:
the vehicle light source device is configured to irradiate, by individually driving the plurality of the first light sources and the plurality of the second light sources, a light distribution pattern onto an irradiation region of the vehicle light source device such that the light distribution pattern includes a cut-off line in at least a part of the irradiation region, the at least the part of the irradiation region being between (i) a group of positions corresponding to the plurality of the first light sources and (ii) a group of positions corresponding to the plurality of the second light sources; and
in a column direction, a length of each of the second light sources is greater than a length of each of the first light sources.

2. The vehicle light source device according to claim 1, wherein:
in the column direction, a length of each second light transmissive member that is greater than a length of each first light transmissive member.

3. The vehicle light source device according to claim 2, wherein:
in the column direction, a length of each second light emitting element is greater than a length of each first light emitting element.

4. The vehicle light source device according to claim 1, further comprising:
a light shielding member holding the plurality of light sources collectively.

5. The vehicle light source device according to claim 1, wherein:
the first light transmissive member contains a first phosphor, and
the second light transmissive member contains a second phosphor.

6. The vehicle light source device according to claim 5, wherein:
the first light transmissive member comprises a first phosphor part containing the first phosphor, and a first light transmissive part arranged on the first phosphor part and not containing the first phosphor, and
the second light transmissive member comprises a second phosphor part containing the second phosphor, and a second light transmissive part arranged on the second phosphor part and not containing the second phosphor.

7. The vehicle light source device according to claim 6, wherein:
an aspect ratio of the second phosphor part is greater than an aspect ratio of the second light emitting element,
an aspect ratio of the second light transmissive part is greater than an aspect ratio of the second phosphor part, and
each respective aspect ratio is a ratio of a length in the column direction to a length in the row direction.

8. The vehicle light source device according to claim 1, wherein:
of intervals between the light sources adjacent in the row direction, an interval between light sources located on an end side is greater than an interval between light sources located on an inner side.

9. The vehicle light source device according to claim 1, wherein:
the plurality of the first light sources include:
a plurality of lower first light sources configured to irradiate light onto a region vertically below the cut-off line in the irradiation region of the vehicle light source device, and
a plurality of upper first light sources configured to irradiate light onto a region vertically above the cut-off line in the irradiation region of the vehicle light source device.

10. The vehicle light source device according to claim 9, wherein:
the plurality of first light sources include:
the plurality of lower first light sources arranged adjacent to each other from one end side in the row direction; and
the plurality of upper first light sources arranged adjacent to each other from the other end side in the row direction; and
an illuminance of a lower first light source that is located closest to the other end side is greater than an illuminance of the upper first light sources.

11. The vehicle light source device according to claim 1, wherein:
an aspect ratio of at least one of the plurality of second light sources has is different from an aspect ratio of others of the plurality of second light sources, each respective aspect ratio being a ratio of a length in the column direction to a length in the row direction.

12. The vehicle light source device according to claim 11, wherein:
among the plurality of second light sources, the second light sources located on an inner side in the row direction have the aspect ratio greater than that of the second light sources located on end sides in the row direction.

13. The vehicle light source device according to claim 11, wherein:
among the plurality of second light sources, a second light source located at at least one end in the row direction includes a plurality of second light emitting elements, each of which is the second light emitting element, and one second light transmissive member, which is the second light transmissive member and is disposed across the plurality of second light emitting elements.

14. The vehicle light source device according to claim 1, wherein:
in the row direction:
among the plurality of first light sources, an area of light emitting surfaces of first light sources located on an inner side is smaller than an area of light emitting surfaces of first light sources located on outer sides; and
among the plurality of second light sources, an area of light emitting surfaces of second light sources located on the inner side is smaller than an area of light emitting surfaces of the second light sources located on the outer sides.

15. The vehicle light source device according to claim 14, wherein:
of intervals between the light sources adjacent to each other in the row direction, an interval between first light sources located on the outer sides is greater than an interval between first light sources located on the inner side.

16. The vehicle light source device according to claim 1, wherein:
an upper surface of the first light transmissive member includes a first upper surface region adjacent to the second light source and a second upper surface region located on a side of the first upper surface region opposite to the second light source, and
the first light source further comprises a light reflecting member disposed in the second upper surface region.

17. The vehicle light source device according to claim 16, wherein:
a luminance of light emitted from the second upper surface region is equal to or greater than 0% and equal to or less than 50% a luminance of light emitted from the first upper surface region.

18. The vehicle light source device according to claim 16, wherein:
in a direction normal to the first upper surface region, a distance from the second upper surface region to a lower surface of the first light transmissive member is less than a distance from the first upper surface region to the lower surface of the first light transmissive member.

19. A vehicle lighting fixture comprising:
the vehicle light source device of claim 1; and
a lens configured to transmit light emitted from the vehicle light source device.
